(19) United States
(12) Patent Application Publication
(10) Pub. No.: US 2018/0053944 A1
(43) Pub. Date: Feb. 22, 2018

(54) Porous Electrodes and Electrochemical Cells and Liquid Flow Batteries Therefrom

(71) Applicant: 3M INNOVATIVE PROPERTIES COMPANY, St. Paul, MN (US)

(72) Inventors: Raymond P. Johnston, Lake Elmo, MN (US); Onur S. Yordem, St. Paul, MN (US); Brian T. Weber, St. Paul, MN (US); Brett J. Sitter, Cottage Grove, MN (US); Bradley W. Eaton, Woodbury, MN (US); Andrew T. Haug, Woodbury, MN (US); Gregory M. Haugen, Edina, MN (US); Ali E. Ozcam, St. Paul, MN (US); Brandon A. Bartling, Woodbury, MN (US); Bharat R. Acharya, Woodbury, MN (US)

(21) Appl. No.: 15/556,679

(22) PCT Filed: Mar. 22, 2016
(86) PCT No.: PCT/US2016/023567

§ 371 Date: Sep. 8, 2017

Related U.S. Application Data
(60) Provisional application No. 62/137,563, filed on Mar. 24, 2015.
(60) Provisional application No. 62/183,441, filed on Jun. 23, 2015.

(51) Int. Cl. H01M 4/86

(52) U.S. Cl. CPC H01M 4/8626; H01M 4/8657; H01M 4/88; H01M 4/8668; H01M 4/8652

(57) ABSTRACT

The present disclosure relates to porous electrodes, membrane-electrode assemblies, electrode assemblies and electro-chemical cells and liquid flow batteries produced therefrom. The disclosure further provides methods of making porous electrodes, membrane-electrode assemblies and electrode assemblies. The porous electrodes include a porous electrode material comprising a non-electrically conductive, polymer particulate; and an electrically conductive carbon particulate; wherein the electrically conductive carbon particulate is at least one of carbon nanotubes and branched carbon nanotubes. The electrically conductive carbon particulate is adhered directly to the surface of the non-electrically conductive, polymer particulate and at least a portion of the non-electrically conductive polymer particulate surface is fused to form a unitary, porous electrode material.

### FIELD

The present invention generally relates to porous electrodes useful in the fabrication of electrochemical cells and batteries. The disclosure further provides methods of making the porous electrodes.

### BACKGROUND

Various components useful in the formation of electrochemical cells and redox flow batteries have been disclosed in the art. Such components are described in, for example, U.S. Pat. Nos. 5,648,184, 8,518,572 and 8,882,057.

### SUMMARY

In one aspect, the present disclosure provides a porous electrode for a liquid flow battery comprising:

a porous electrode material comprising:
a non-electrically conductive, polymer particulate; and
an electrically conductive carbon particulate; wherein the electrically conductive carbon particulate is at least one of carbon nanotubes and branched carbon nanotubes, the electrically conductive carbon particulate is adhered directly to the surface of the non-electrically conductive, polymer particulate and wherein at least a portion of the non-electrically conductive polymer particulate surface is fused to form a unitary, porous electrode material.

In one aspect, the present disclosure provides a membrane-electrode assembly for a liquid flow battery comprising:
an ion exchange membrane having a first surface and an opposed second surface; and
a first porous electrode according to any one of the porous electrode embodiments of the present disclosure, having a first major surface and a second major surface, wherein the first major surface of the first porous electrode is adjacent the first surface of the ion exchange membrane.

In another aspect, the present disclosure provides an electrode assembly for a liquid flow battery comprising:
a first porous electrode according to any one of the porous electrodes of the present disclosure, having a first major surface and a second major surface; and
a first microporous protection layer having a first surface and an opposed second surface; wherein the first major surface of the porous electrode is proximate the second surface of the first microporous protection layer and wherein the first microporous protection layer comprises a polymer resin and an electrically conductive carbon particulate and, optionally, a non-electrically conductive particulate.

In another aspect, the present disclosure provides an electrochemical cell for a liquid flow battery comprising a porous electrode according to any one of the porous electrode embodiments of the present disclosure.

In another aspect, the present disclosure provides an electrochemical cell for a liquid flow battery comprising a membrane-electrode assembly according to any one of the membrane-electrode assembly embodiments of the present disclosure.

In another aspect, the present disclosure provides an electrochemical cell for a liquid flow battery comprising an electrode assembly according to any one of the electrode assembly embodiments of the present disclosure.

In another aspect, the present disclosure provides a liquid flow battery comprising at least one porous electrode according to any one of the porous electrode embodiments of the present disclosure.

In another aspect, the present disclosure provides a liquid flow battery comprising at least one membrane-electrode assembly according to any one of the membrane-electrode assembly embodiments of the present disclosure.

In yet another aspect, the present disclosure provides a liquid flow battery comprising at least one electrode assembly according to any one of the electrode assembly embodiments of the present disclosure.

### BRIEF DESCRIPTION OF THE DRAWINGS

FIG. 1A is a schematic cross-sectional side view of an exemplary membrane-electrode assembly according to one exemplary embodiment of the present disclosure.

FIG. 1B is a schematic cross-sectional side view of an exemplary membrane-electrode assembly according to one exemplary embodiment of the present disclosure.

FIG. 1C is a schematic cross-sectional side view of an exemplary membrane-electrode assembly according to one exemplary embodiment of the present disclosure.

FIG. 1D is a schematic cross-sectional side view of an exemplary membrane-electrode assembly according to one exemplary embodiment of the present disclosure.

FIG. 2 is a schematic cross-sectional side view of an exemplary electrode assembly according to one exemplary embodiment of the present disclosure.

FIG. 3 is a schematic cross-sectional side view of an exemplary electrochemical cell according to one exemplary embodiment of the present disclosure.

FIG. 4 is a schematic cross-sectional side view of an exemplary electrochemical cell stack according to one exemplary embodiment of the present disclosure.

FIG. 5 is a schematic view of an exemplary single cell liquid flow battery according to one exemplary embodiment of the present disclosure.

FIG. 6 shows polarization curves for Examples 1, 4 and 6.

Repeated use of reference characters in the specification and drawings is intended to represent the same or analogous features or elements of the disclosure. The drawings may not be drawn to scale. As used herein, the word “between”, as applied to numerical ranges, includes the endpoints of the ranges, unless otherwise specified. The recitation of numerical ranges by endpoints includes all numbers within that range (e.g. 1 to 5 includes 1, 1.5, 2, 2.75, 3, 3.80, 4, and 5) and any range within that range. Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

It should be understood that numerous other modifications and embodiments can be devised by those skilled in the art, which fall within the scope and spirit of the principles of the disclosure. All scientific and technical terms used herein have meanings commonly used in the art unless otherwise specified. The definitions provided herein are to facilitate understanding of certain terms used frequently herein and are not meant to limit the scope of the present disclosure. As used in this specification and the appended claims, the singular forms “a”, “an”, and “the” encompass embodiments having plural referents, unless the context clearly dictates otherwise. As used in this specification and the appended claims, the term “or” is generally employed in its sense including “and/or” unless the context clearly dictates otherwise.

Throughout this text, when a surface of one substrate is in “contact” with the surface of another substrate, there are no intervening layer(s) between the two substrates and at least a portion of the surfaces of the two substrates are in physical contact.

Throughout this text, if a surface of a first substrate is “adjacent” to a surface of a second substrate, the two surfaces are considered to be facing one another. They may be in contact with one another or there may not be in contact with one another, an intervening third substrate or substrates being disposed between them. Throughout this text, if a surface of a first substrate is “proximate” a surface of a second substrate, the two surface are considered to be facing one another and to be in close proximity to one another, i.e. to be within less than 500 microns, less than 250 microns, less than 100 microns or even in contact with one another. However, there may be one or more intervening substrates disposed between the substrate surfaces. If a surface of a first substrate is “in contact” with a surface of a second substrate, at least a portion of the two surfaces are in physical contact, i.e. there is no intervening substrate disposed between them.

### DETAILED DESCRIPTION

A single electrochemical cell, which may be used in the fabrication of a liquid flow battery (e.g. a redox flow battery), generally, include two porous electrodes, an anode and a cathode; an ion permeable membrane disposed between the two electrodes, providing electrical insulation between the electrodes and providing a path for one or more select ionic species to pass between the anode and cathode half-cells; anode and cathode flow plates, the former positioned adjacent the anode and the later positioned adjacent the cathode, each containing one or more channels which allow the anolyte and catholyte electrolytic solutions to contact and penetrate into the anode and cathode, respectively. The anode, cathode and membrane of the cell or battery will be referred to herein as a membrane-electrode assembly (MEA). In a redox flow battery containing a single electrochemical cell, for example, the cell would also include two current collectors, one adjacent to and in contact with the exterior surface of the anode flow plate and one adjacent to and in contact with the exterior surface of the cathode flow plate. The current collectors allow electrons generated during cell discharge to connect to an external circuit and do useful work. A functioning redox flow battery or electrochemical cell also includes an anolyte, anolyte reservoir and corresponding fluid distribution system (piping and at least one or more pumps) to facilitate flow of anolyte into the anode half-cell, and a catholyte, catholyte reservoir and corresponding fluid distribution system to facilitate flow of catholyte into the cathode half-cell. Although pumps are typically employed, gravity feed systems may also be used. During discharge, active species, e.g. cations, in the anolyte are oxidized and the corresponding electrons flow though the exterior circuit and load to the cathode where they reduce active species in the catholyte. As the active species for electrochemical oxidation and reduction are contained in the anolylte and catholyte, redox flow cells and batteries have the unique feature of being able to store their energy outside the main body of the electrochemical cell, i.e. in the anolyte. The amount of storage capacity is mainly limited by the amount of anolyte and catholyte and the concentration of active species in these solutions. As such, redox flow batteries may be used for large scale energy storage needs associated with wind farms and solar energy plants, for example, by scaling the size of the reservoir tanks and active species concentrations, accordingly. Redox flow cells also have the advantage of having their storage capacity being independent of their power. The power in a redox flow battery or cell is generally determined by the size and number of electrode-membrane assemblies along with their corresponding flow plates (sometimes referred to in total as a “stack”) within the battery. Additionally, as redox flow batteries are being designed for electrical grid use, the voltages must be high. However, the voltage of a single redox flow electrochemical cell is generally less than 3 volts (difference in the potential of the half-cell reactions making up the cell). As such, hundreds of cells are required to be connected in series to generate voltages great enough to have practical utility and a significant amount of the cost of the cell or battery relates to the cost of the components making an individual cell.

At the core of the redox flow electrochemical cell and battery is the membrane-electrode assembly (anode, cathode and ion permeable membrane disposed there between). The design of the MEA is critical to the power output of a redox flow cell and battery. Subsequently, the materials selected for these components are critical to performance. Materials used for the electrodes may be based on carbon, which provides desirable catalytic activity for the oxidation/reduction reactions to occur and is electrically conductive to provide electron transfer to the flow plates. The electrode materials may be porous, to provide greater surface area for the oxidation/reduction reactions to occur. Porous electrodes may include carbon fiber based papers, felts, and cloths. When porous electrodes are used, the electrolytes may penetrate into the body of the electrode, access the additional surface area for reaction and thus increase the rate of energy generation per unit volume of the electrode. Also, as one or both of the anolyte and catholyte may be water based, i.e. an aqueous solution, there may be a need for the electrode to have a hydrophilic surface, to facilitate electrolyte permeation into the body of a porous electrode. Surface treatments may be used to enhance the hydrophilicity of the redox flow electrodes. This is in contrast to fuel cell electrodes which typically are designed to be hydrophobic, to prevent moisture from entering the electrode and corresponding catalyst layer/region, and to facilitate removal of moisture from the electrode region in, for example, a hydrogen/oxygen based fuel cell.

Materials used for the ion permeable membrane are required to be good electrical insulators while enabling one or more select ions to pass through the membrane. These material are often fabricated from polymers and may include ionic species to facilitate ion transfer through the membrane. Thus, the material making up the ion permeable membrane may be an expensive specialty polymer.

As hundreds of MEAs may be required per cell stack and battery, the electrodes (anode and cathode) and/or ion permeable membrane may be a significant cost factor with respect to the overall cost of the MEA and the overall cost of a cell and battery. Thus, there is a need for new electrodes that can reduce the cost of the MEAs and the overall cost of a cell and/or battery.

Additionally, as it is desirable to minimize the cost of the MEAs, another approach to minimizing their cost is to reduce the volume of the ion permeable membrane used therein. However, as the power output requirements of the cell help define the size requirements of a given MEA and thus the size of the membrane, with respect to its length and width dimensions (larger length and width, generally, being preferred), it may only be possible to decrease the thickness of the ion permeable membrane, in order to decrease the cost of the MEA. However, by decreasing the thickness of the ion permeable membrane, a problem has been identified. As the membrane thickness has been decreased, it has been found that the relatively stiff fibers, e.g. carbon fibers, used to fabricate the porous electrodes, can penetrate through the thinner membrane and contact the corresponding electrode of the opposite half-cell. This causes detrimental localized shorting of the cell, a loss in the power generated by the cell and a loss in power of the overall battery. Thus, there is a need for improved electrodes useful in membrane-electrode assemblies that can prevent this localized shorting while maintaining the required electrolyte transport through the electrode without inhibiting the required oxidation/reduction reaction of the electrochemical cells and batteries fabricated therefrom.

The present disclosure provides porous electrodes having a new design that includes at least one polymer and at least one conductive carbon particulate. The addition of polymer may reduce the cost of the porous electrode compared to the cost of traditional carbon fiber based electrodes, e.g. carbon papers. The porous electrodes of the present disclosure, may also reduce the localized shorting that has been found to be an issue when the membrane thickness is reduced and may allow for even thinner membranes to be used, further facilitating cost reduction of the MEAs and corresponding cells and batteries made therefrom. The porous electrodes of the present disclosure are useful in the fabrication of MEAs, electrode assemblies, liquid flow, e.g. redox flow, electrochemical cells and batteries. Liquid flow electrochemical cells and batteries may include cells and batteries having a single half-cell being a liquid flow type or both half-cells being a liquid flow type. The electrode may be a component of a MEA or a component of an electrode assembly. An electrode assembly includes a porous electrode and a microporous protection layer. The present disclosure also includes liquid flow electrochemical cells and batteries containing porous electrodes, MEAs and/or electrode assemblies that include at least one porous electrode of the present disclosure. The present disclosure further provides methods of fabricating the porous electrodes, membrane-electrode assemblies and electrode assemblies useful in the fabrication of liquid flow electrochemical cells and batteries.

In one embodiment, the present disclosure a porous electrode for a liquid flow battery including a porous electrode material comprising a non-electrically conductive, polymer particulate and an electrically conductive carbon particulate. The electrically conductive carbon particulate is at least one of carbon nanotubes and branched carbon nanotubes and the electrically conductive carbon particulate is adhered directly to the surface of the non-electrically conductive, polymer particulate. At least a portion of the non-electrically conductive polymer particulate surface is fused to form a unitary, porous electrode material.

An electrode is considered “porous” and an electrode material is considered “porous” if it allows a liquid to flow from one exterior surface of a 3-dimensional porous electrode structure containing the porous electrode material to the exterior of an opposing surface of the 3-dimensional structure.

In some embodiments, the polymer of the porous electrode material of the porous electrode may be at least one of a polymer particulate and polymer binder resin. In some embodiments, the polymer may be a polymer particulate. In some embodiments, the polymer may be a polymer binder resin. In some embodiments the polymer does not include a polymer particulate. In some embodiments, the polymer does not include a polymer binder resin.

The term “particulate”, with respect to both an electrically conductive carbon particulate and a polymer particulate is meant to include particles, flakes, fibers, dendrites and the like. Particulate particles generally include particulates that have aspect ratios of length to width and length to thickness both of which are between about 1 and about 5. Particle size may be from between about 0.001 microns to about 100 microns, from between about 0.001 microns to about 50 microns, from between about 0.001 to about 25 microns, from between about 0.001 microns to about 10 microns, from about 0.001 microns to about 1 microns, from between about 0.01 microns and about 100 microns, from between about 0.01 microns to about 50 microns, from between about 0.01 to about 25 microns, from between about 0.01 microns to about 10 microns, from about 0.01 microns to about 1 microns, from between about 0.05 microns to about 100 microns, from between about 0.05 microns to about 50 microns, from between about 0.05 to about 25 microns, from between about 0.05 microns to about 10 microns, from about 0.05 microns to about 1 microns, from between about 0.1 microns and about 100 microns, from between about 0.1 microns to about 50 microns, from between about 0.1 to about 25 microns, from between about 0.1 microns to about 10 microns, or even from between about 0.1 microns to about 1 microns. Particles may be spheroidal in shape.

Particulate flakes generally include particulates that have a length and a width each of which is significantly greater than the thickness of the flake. A flake includes particulates that have aspect ratios of length to thickness and width to thickness each of which is greater than about 5. There is no particular upper limit on the length to thickness and width to thickness aspect ratios of a flake. Both the length to thickness and width to thickness aspect ratios of the flake may be between about 6 and about 1000, between about 6 and about 500, between about 6 and about 100, between about 6 and about 50, between about 6 and about 25, between about 10 and about 500, between 10 and about 150, between 10 and about 100, or even between about 10 and about 50. The length and width of the flake may each be from between about 0.001 microns to about 50 microns, from between about 0.001 to about 25 microns, from between about 0.001 microns to about 10 microns, from about 0.001 microns to about 1 microns, from between about 0.01 microns to about 50 microns, from between about 0.01 to about 25 microns, from between about 0.01 microns to about 10 microns, from about 0.01 microns to about 1 microns, from between about 0.05 microns to about 50 microns, from between about 0.05 to about 25 microns, from between about 0.05 microns to about 10 microns, from about 0.05 microns to about 1 microns, from between about 0.1 microns to about 50 microns, from between about 0.1 to about 25 microns, from between about 0.1 microns to about 10 microns, or even from between about 0.1 microns to about 1 microns. Flakes may be platelet in shape.

Particulate dendrites include particulates having a branched structure. The particle size of the dendrites may be the same as those disclosed for the particulate particles, discussed above.

Particulate fibers generally include particulates that have aspect ratios of the length to width and length to thickness both of which are greater about 10 and a width to thickness aspect ratio less than about 5. For a fiber having a cross sectional area that is in the shape of a circle, the width and thickness would be the same and would be equal to the diameter of the circular cross-section. There is no particular upper limit on the length to width and length to thickness aspect ratios of a fiber. Both the length to thickness and length to width aspect ratios of the fiber may be between about 10 and about 1000000, between 10 and about 100000, between 10 and about 1000, between 10 and about 500, between 10 and about 250, between 10 and about 100, between about 10 and about 50, between about 20 and about 1000000, between 20 and about 100000, between 20 and about 1000, between 20 and about 500, between 20 and about 250, between 20 and about 100 or even between about 20 and about 50. The width and thickness of the fiber may each be from between about 0.001 to about 100 microns, from between about 0.001 microns to about 50 microns, from between about 0.001 to about 25 microns, from between about 0.001 microns to about 10 microns, from about 0.001 microns to about 1 microns, from between about 0.01 to about 100 microns, from between about 0.01 microns to about 50 microns, from between about 0.01 to about 25 microns, from between about 0.01 microns to about 10 microns, from about 0.01 microns to about 1 microns, from between about 0.05 to about 100 microns, from between about 0.05 microns to about 50 microns, from between about 0.05 to about 25 microns, from between about 0.05 microns to about 10 microns, from about 0.05 microns to about 1 microns, from between about 0.1 to about 100 microns, from between about 0.1 microns to about 50 microns, from between about 0.1 to about 25 microns, from between about 0.1 microns to about 10 microns, or even from between about 0.1 microns to about 1 microns. In some embodiments the thickness and width of the fiber may be the same.

In some embodiments, some particulates could be non-conductive, high-surface energy and wetting.

The electrically conductive carbon particulate, includes but is not limited to, glass like carbon, amorphous carbon, graphene, graphite, e.g. graphitized carbon, carbon dendrites, carbon nanotubes, branched carbon nanotubes, e.g. carbon nanotrees. In some embodiments, the electrically conductive carbon particulate is at least one of carbon particles, carbon flakes, carbon fibers, carbon dendrites, carbon nanotubes and branched carbon nanotubes, e.g. carbon nanotrees. In some embodiments, the electrically conductive carbon particulate is at least one of graphite particles, graphite flakes, graphite fibers and graphite dendrites. In some embodiments, the graphite may be at least one of graphite particles, graphite flakes, and graphite dendrites. In some embodiments, the electrically conductive carbon particulate carbon does not include carbon fibers.

In some embodiments, the electrically conductive particulate is at least one of carbon nanotubes and branched carbon nanotubes. Carbon nanotubes are allotropes of carbon with a cylindrical nanostructure. Carbon nanotubes may be produced with length-to-diameter ratio of up to 132,000,000:1, significantly larger than for any other material, including carbon fiber. Carbon nanotubes may have diameters of from about 1 to 5 nanometers, orders of magnitude smaller than carbon and/or graphite fibers, which may have diameters from 5 to about 10 microns. Carbon nanotubes may have a diameter from about 0.3 nanometers to about 100 nanometers, from about 0.3 nanometers to about 50 nanometers, from about 0.3 nanometers to about 20 nanometers, from about 0.3 nanometers to about 10 nanometers, from about 1 nanometer to about 50 nanometers, from about 1 nanometer to about 20 nanometers, or even from about 1 nanometers to about 10 nanometers. Carbon nanotubes may have a length between about 0.25 microns and about 1000 microns, between about 0.5 microns and about 500 microns, or even between about 1 micron and about 100 microns. Branched carbon nanotubes, e.g. nanotrees may have a diameter from about 0.3 nanometers to about 100 nanometers. Branched carbon nanotubes include multiple, carbon nanotube side branches that are covalently bonded with the main carbon nanotube, i.e. the carbon nanotube stem. Branched carbon nanotubes, with their tree-like, dendritic geometry, may have extensively high surface area. Various synthesis methods have been developed to fabricate such complex structured carbon nanotubes with multiple terminals, including but not limited to the template method, carbon nanotube welding method, solid fiber carbonization, as well as the direct current plasma enhanced chemical vapor deposition (CVD) and several other additive-, catalyst-, or flow fluctuation-based CVD methods. In some embodiments, the diameter of the main carbon nanotube and the diameter of the carbon nanotube side branches of branched carbon nanotubes may be from about 0.3 nanometers to about 100 nanometers, from about 0.3 nanometers to about 50 nanometers, from about 0.3 nanometers to about 20 nanometers, from about 0.3 nanometers.

In some embodiments, the electrically conductive particulate is at least one of carbon nanotubes and branched carbon nanotubes. In some embodiments, the electrically conductive carbon particulate includes or consists essentially of carbon nanotubes and branched carbon nanotubes and the weight fraction of branched carbon nanotubes, relative to the total weight of carbon nanotubes and branched carbon nanotubes, may be from about 0.1 to about 1, from about 0.1 to about 0.9, from about 0.1 from 0.8, from about 0.2 to about 1, from about 0.2 to about 0.9, from about 0.2 from 0.8, from about 0.3 to about 1, from about 0.3 to about 0.9, from about 0.3 from 0.8, from about 0.4 to about 1, from about 0.4 to about 0.9, from about 0.4 from 0.8, from about 0.5 to about 1, from about 0.5 to about 0.9, or even from about 0.5 from 0.8. The electrically conducive particulate which includes at least one of carbon nanotubes and branched carbon nanotubes and/or which includes carbon nanotubes and branched carbon nanotubes may further comprises graphite particulate. In these embodiments, the weight fraction of graphite particulate to the total weight of electrically conductive carbon particulate may be from about 0.05 to about 1, from about 0.05 to about 0.8, from about 0.05 to about 0.6, from about 0.05 to about 0.5, from about 0.05 to about 0.4, from about 0.1 to about 1, from about 0.1 to about 0.8, from about 0.1 to about 0.6, from about 0.1 to about 0.5, from about 0.1 to about 0.4, from about 0.2 to about 1, from about 0.2 to about 0.8, from about 0.2 to about 0.6, from about 0.2 to about 0.5, or even from about 0.2 to about 0.4.

In some embodiments, the electrically conductive carbon particulate may be surface treated. Surface treatment may enhance the wettability of the electrode to a given anolyte or catholyte or to provide or enhance the electrochemical activity of the electrode relative to the oxidation-reduction reactions associated with the chemical composition of a given anolyte or catholyte. Surface treatments include, but are not limited to, at least one of chemical treatments, thermal treatments and plasma treatments. In some embodiments, the electrically conductive carbon particulate has enhanced electrochemical activity, produced by at least one of chemical treatment, thermal treatment and plasma treatment. The term “enhanced” means that the electrochemical activity of the electrically conductive carbon particulate is increased after treatment relative to the electrochemical activity of the electrically conductive carbon particulate prior to treatment. Enhanced electrochemical activity may include at least one of increased current density, reduced oxygen evolution and reduced hydrogen evolution. The electrochemical activity can be measured by fabricating a porous electrode from the electrically conductive carbon particulate (prior to and after treatment) and comparing the current density generated in an electrochemical cell by the electrode, higher current density indicating enhancement of the electrochemical activity. Cyclic voltammetry can be used to measure activity improvement, i.e. changes in current density. In some embodiments, the electrically conductive particulate is hydrophilic.

In some embodiments, the amount of electrically conductive carbon particulate contained in the electrode, on a weight basis, may be from about 5 to about 99 percent, from about 5 to about 95 percent, from about 5 to about 90 percent, from about 5 to about 80 percent, from about 5 to about 70 percent, from about 10 to about 99 percent, from about 10 to about 95 percent, from about 10 to about 90 percent, from about 10 to about 80 percent, from about 10 to about 70 percent, from about 25 to about 99 percent, 25 to about 95 percent, from about 25 to about 90 percent, from about 25 to about 80 percent, from about 25 to about 70 percent, from about 30 to about 99 percent, from about 30 to about 95 percent, from about 30 to about 90 percent, from about 30 to about 80 percent, from about 30 to about 70 percent, from about 40 to about 99 percent, from about 40 to about 95 percent, from about 40 to about 90 percent, from about 40 to about 80 percent, from about 40 to about 70 percent, from about 50 to about 99 percent, 50 to about 95 percent, from about 50 to about 90 percent, from about 50 to about 80 percent, from about 50 to about 70 percent, from about 60 to about 99 percent, 60 to about 95 percent, from about 60 to about 90 percent, from about 60 to about 80 percent, or even from about 60 to about 70 percent.

The polymer of the porous electrode material of the porous electrode may be at least one of a polymer particulate and polymer binder resin. In some embodiments of the present disclosure, the polymeric particulate may be at least one of polymer particles, polymer flakes, polymer fibers and polymer dendrites. In some embodiments, the polymer is fused polymer particulate. Fused polymer particulate may be formed from polymer particulates that are brought to a temperature to allow the contact surfaces of adjacent polymer particulates to fuse together. After fusing the individual particulates that formed the fused polymer particulate can still be identified. A fused polymer particulate is porous. Fused polymer particulate is not particulate that has been completely melted to form a solid substrate, i.e. a non-porous substrate. In some embodiments, the polymer particulate may be fused at a temperature that is not less than about 30 degrees centigrade, not less than about 20 degrees centigrade or even not less than about 10 degrees centigrade lower than the lowest glass transition temperature of the polymer particulate. The polymer particulate may have more than one glass transition temperatures, if, for example, it is a block copolymer or a core-shell polymer. In some embodiments, the polymer particulate may be fused at a temperature that is below the highest melting temperature of the polymer particulate or, when the polymer particulate is an amorphous polymer, no greater than 50 degrees centigrade, no greater than 30 degrees centigrade or even no greater than 10 degrees centigrade above the highest glass transition temperature of the polymer particulate.

In some embodiments of the present disclosure, the polymer may be a polymer binder resin and the polymer binder resin may be derived from a polymer precursor liquid. A polymer precursor liquid may be at least one of a polymer solution and a reactive polymer precursor liquid, each capable of being at least one of polymerized, cured, dried and fused to form a polymer binder resin. A polymer solution may include at least one polymer dissolved in at least one solvent. A polymer solution may be capable of being at least one of polymerized, cured, dried and fused to form a polymer binder resin. In some embodiments, the polymer solution is dried to form a polymer binder resin. A reactive polymer precursor liquid includes at least one of liquid monomer and liquid oligomer. The monomer may be a single monomer or may be a mixture of at least two different monomers. The oligomer may be a single oligomer or a mixture at least two different oligomers. Mixtures of one or more monomers and one or more oligomers may also be used. The reactive polymer precursor liquid may include at least one, optional, solvent. The reactive polymer precursor liquid may include at least one, optional, polymer, which is soluble in the liquid components of the reactive polymer precursor liquid. The reactive polymer precursor liquid may be capable of being at least one of polymerized, cured, dried and fused to form a polymer binder resin. In some embodiments, the reactive polymer precursor liquid is cured to form a polymer binder resin. In some embodiments, the reactive polymer precursor liquid is polymerized to form a polymer binder resin. In some embodiments, the reactive polymer precursor liquid is cured and polymerized to form a polymer binder resin. The terms “cure”, “curing”, “cured” and the like are used herein to refer to a reactive polymer precursor liquid that is increasing its molecular weight through one or more reactions that include at least one crosslinking reaction. Generally, curing leads to a thermoset material that may be insoluble in solvents. The terms “polymerize”, “polymerizing”, “polymerized and the like, generally refer to a reactive polymer precursor liquid that is increasing its molecular weight through one or more reactions that do not include a crosslinking reaction. Generally, polymerization leads to a thermoplastic material that may be soluble in an appropriate solvent. A reactive polymer precursor liquid that is reacting by at least one crosslinking reaction and at least one polymerization reaction may form either a thermoset or thermoplastic material, depending on the degree of polymerization achieved and the amounted crosslinking of the final polymer. Monomers and/or oligomers useful in the preparation of a reactive polymer precursor liquid include, but are not limited to, monomers and oligomers conventionally used to form the polymers, e.g. thermosets, thermoplastics and thermoplastic elastomers, described herein (below). Polymers useful in the preparation of a polymer solution include, but are not limited to the thermoplastic and thermoplastic elastomer polymers described herein (below).

In the some embodiments of the present disclosure, the electrically conductive carbon particulate may be adhered to the polymer, polymer particulate and/or polymer binder resin. In some embodiments of the present disclosure, the electrically conductive carbon particulate may be adhered to the surface of the polymer particulate. In some embodiments of the present disclosure, the electrically conductive carbon particulate may be adhered to the surface of the fused polymer particulate.

The polymer of the electrode may be selected to facilitate the transfer of select ion(s) of the electrolytes through the electrode. This may be achieved by allowing the electrolyte to easily wet a given polymer. The material properties, particularly the surface wetting characteristics of the polymer may be selected based on the type of anolyte and catholyte solution, i.e. whether they are aqueous based or non-aqueous based. As disclosed herein, an aqueous based solution is defined as a solution wherein the solvent includes at least 50% water by weight. A non-aqueous base solution is defined as a solution wherein the solvent contains less than 50% water by weight. In some embodiments, the polymer of the electrode may be hydrophilic. This may be particularly beneficial when the electrode is to be used in conjunction with aqueous anolyte and/or catholyte solutions. In some embodiments the polymer may have a surface contact angle with water, catholyte and/or anolyte of less than 90 degrees. In some embodiments, the polymer may have a surface contact with water, catholyte and/or anolyte of between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees.

Polymer of the electrode, which may be a polymer particulate or a polymer binder resin, may include thermoplastic resins (including thermoplastic elastomer), thermoset resins (including glassy and rubbery materials) and combinations thereof. Useful thermoplastic resins include, but are not limited to, homopolymers, copolymers and blends of at least one of polyalkylenes, e.g. polyethylene, high molecular weight polyethylene, high density polyethylene, ultra-high molecular weight polyethylene, polypropylene, high molecular weight polypropylene; polyacrylates; polymethacrylates, styrene and styrene based random and block copolymers, e.g. styrene-butadiene-styrene; polyesters, e.g. polyethylene terephtahalate; polycarbonates, polyamides, polyamide-amines; polyalkylene glycols, e.g. polyethylene glycol and polypropylene glycol; polyurethanes; polyethers; chlorinated polyvinyl chloride; fluoropolymers including perfluorinated fluoropolymers, e.g. polytetrafluoroethylene (PTFE) and partially fluorinated fluoropolymer, e.g., polyvinylidene fluoride, each of which may be semi-crystalline and/or amorphous; polyimides, polyetherimides, polysulphones; polyphenylene oxides; and polyketones. Useful thermoset resins include, but are not limited to, homopolymer, copolymers and/or blends of at least one of epoxy resin, phenolic resin, polyurethanes, urea-formadehyde resin and melamine resin.

In some embodiments, the polymer has a softening temperature, e.g. the glass transition temperature and/or the melting temperature of between about 20 degrees centigrade and about 400 degrees centigrade, between about 20 degrees centigrade and about 350 degrees centigrade, between about 20 degrees centigrade and about 300 degrees centigrade, between about 20 degrees centigrade and about 250 degrees centigrade, between about 20 degrees centigrade and about 200 degrees centigrade, between about 20 degrees centigrade and about 150 degrees centigrade, between about 35 degrees centigrade and about 400 degrees centigrade, between about 35 degrees centigrade and about 350 degrees centigrade, between about 35 degrees centigrade and about 300 degrees centigrade, between about 35 degrees centigrade and about 250 degrees centigrade, between about 35 degrees centigrade and about 200 degrees centigrade, between about 35 degrees centigrade and about 150 degrees centigrade, between about 50 degrees centigrade and about 400 degrees centigrade, between about 50 degrees centigrade and about 350 degrees centigrade, between about 50 degrees centigrade and about 300 degrees centigrade, between about 50 degrees centigrade and about 250 degrees centigrade, between about 50 degrees centigrade and about 200 degrees centigrade, between about 50 degrees centigrade and about 150 degrees centigrade, between about 75 degrees centigrade and about 400 degrees centigrade, between about 75 degrees centigrade and about 350 degrees centigrade, between about 75 degrees centigrade and about 300 degrees centigrade, between about 75 degrees centigrade and about 250 degrees centigrade, between about 75 degrees centigrade and about 200 degrees centigrade, or even between about 75 degrees centigrade and about 150 degrees centigrade.

In some embodiments, the polymer particulate is composed of two or more polymers and has a core-shell structure, i.e. an inner core comprising a first polymer and an outer shell comprising a second polymer. A core-shell structure is sometimes referred to as a core-sheath structure. In some embodiments the polymer of the outer shell, e.g. second polymer, has a softening temperature, e.g. the glass transition temperature and/or the melting temperature that is lower than softening temperature of the first polymer. In some embodiments, the second polymer has a softening temperature, e.g. the glass transition temperature and/or the melting temperature of between about 20 degrees centigrade and about 400 degrees centigrade, between about 20 degrees centigrade and about 350 degrees centigrade, between about 20 degrees centigrade and about 300 degrees centigrade, between about 20 degrees centigrade and about 250 degrees centigrade, between about 20 degrees centigrade and about 200 degrees centigrade, between about 20 degrees centigrade and about 150 degrees centigrade, between about 35 degrees centigrade and about 400 degrees centigrade, between about 35 degrees centigrade and about 350 degrees centigrade, between about 35 degrees centigrade and about 300 degrees centigrade, between about 35 degrees centigrade and about 250 degrees centigrade, between about 35 degrees centigrade and about 200 degrees centigrade, between about 35 degrees centigrade and about 150 degrees centigrade, between about 50 degrees centigrade and about 400 degrees centigrade, between about 50 degrees centigrade and about 350 degrees centigrade, between about 50 degrees centigrade and about 300 degrees centigrade, between about 50 degrees centigrade and about 250 degrees centigrade, between about 50 degrees centigrade and about 200 degrees centigrade, between about 50 degrees centigrade and about 150 degrees centigrade, between about 75 degrees centigrade and about 400 degrees centigrade, between about 75 degrees centigrade and about 350 degrees centigrade, between about 75 degrees centigrade and about 300 degrees centigrade, between about 75 degrees centigrade and about 250 degrees centigrade, between about 75 degrees centigrade and about 200 degrees centigrade, or even between about 75 degrees centigrade and about 150 degrees centigrade.

The polymer of the electrode may be an ionic polymer or non-ionic polymer. Ionic polymer include polymer wherein a fraction of the repeat units are electrically neutral and a fraction of the repeat units have an ionic functional group, i.e. an ionic repeat unit. In some embodiments, the polymer is an ionic polymer, wherein the ionic polymer has a mole fraction of repeat units having an ionic functional group of between about 0.005 and about 1. In some embodiments, the polymer is a non-ionic polymer, wherein the non-ionic polymer has a mole fraction of repeat units having an ionic functional group of from less than about 0.005 to about 0. In some embodiments, the polymer is a non-ionic polymer, wherein the non-ionic polymer has no repeat units having an ionic functional group. In some embodiments, the polymer consists essentially of an ionic polymer. In some embodiments, the polymer consists essentially of a non-ionic polymer. Ionic polymer includes, but is not limited to, ion exchange resins, ionomer resins and combinations thereof. Ion exchange resins may be particularly useful.

As broadly defined herein, ionic resin include resin wherein a fraction of the repeat units are electrically neutral and a fraction of the repeat units have an ionic functional group. In some embodiments, the ionic resin has a mole fraction of repeat units with ionic functional groups between about 0.005 and 1. In some embodiments, the ionic resin is a cationic resin, i.e. its ionic functional groups are negatively charged and facilitate the transfer of cations, e.g. protons, optionally, wherein the cationic resin is a proton cationic resin. In some embodiments, the ionic resin is an anionic exchange resin, i.e. its ionic functional groups are positively charged and facilitate the transfer of anions. The ionic functional group of the ionic resin may include, but is not limited, to carboxylate, sulphonate, sulfonamide, quaternary ammonium, thiuronium, guanidinium, imidazolium and pyridinium groups. Combinations of ionic functional groups may be used in an ionic resin.

Ionomer resin include resin wherein a fraction of the repeat units are electrically neutral and a fraction of the repeat units have an ionic functional group. As defined herein, an ionomer resin will be considered to be a resin having a mole fraction of repeat units having ionic functional groups of no greater than about 0.15. In some embodiments, the ionomer resin has a mole fraction of repeat units having ionic functional groups of between about 0.005 and about 0.15, between about 0.01 and about 0.15 or even between about 0.3 and about 0.15. In some embodiments the ionomer resin is insoluble in at least one of the anolyte and catholyte. The ionic functional group of the ionomer resin may include, but is not limited, to carboxylate, sulphonate, sulfonamide, quaternary ammonium, thiuronium, guanidinium, imidazolium and pyridinium groups. Combinations of ionic functional groups may be used in an ionomer resin. Mixtures of ionomer resins may be used. The ionomers resin may be a cationic resin or an anionic resin. Useful ionomer resin include, but are not limited to NAFION, available from DuPont, Wilmington, Del.; AQUIVION, a perfluorosulfonic acid, available from SOLVAY, Brussels, Belgium; FLEMION and SELEMION, fluoropolomer ion exchange resin, from Asahi Glass, Tokyo, Japan; FUMASEP ion exchange resin, including FKS, FKB, FKL, FKE cation exchange resins and FAB, FAA, FAP and FAD anionic exchange resins, available from Fumatek, Bietigheim-Bissingen, Germany, polybenzimidazols, and ion exchange materials and membranes described in U.S. Pat. No. 7,348,088, incorporated herein by reference in its entirety.

Ion exchange resin include resin wherein a fraction of the repeat units are electrically neutral and a fraction of the repeat units have an ionic functional group. As defined herein, an ion exchange resin will be considered to be a resin having a mole fraction of repeat units having ionic functional groups of greater than about 0.15 and less than about 1.00. In some embodiments, the ion exchange resin has a mole fraction of repeat units having ionic functional groups of greater than about 0.15 and less than about 0.90, greater than about 0.15 and less than about 0.80, greater than about 0.15 and less than about 0.70, greater than about 0.30 and less than about 0.90, greater than about 0.30 and less than about 0.80, greater than about 0.30 and less than about 0.70 greater than about 0.45 and less than about 0.90, greater than about 0.45 and less than about 0.80, and even greater than about 0.45 and less than about 0.70. The ion exchange resin may be a cationic exchange resin or may be an anionic exchange resin. The ion exchange resin may, optionally, be a proton ion exchange resin. The type of ion exchange resin may be selected based on the type of ion that needs to be transported between the anolyte and catholyte through the ion permeable membrane. In some embodiments the ion exchange resin is insoluble in at least one of the anolyte and catholyte. The ionic functional group of the ion exchange resin may include, but is not limited, to carboxylate, sulphonate, sulfonamide, quaternary ammonium, thiuronium, guanidinium, imidazolium and pyridinium groups. Combinations of ionic functional groups may be used in an ion exchange resin. Mixtures of ion exchange resins resin may be used. Useful ion exchange resins include, but are not limited to, fluorinated ion exchange resins, e.g. perfluorosulfonic acid copolymer and perfluorosulfonimide copolymer, a sulfonated polysulfone, a polymer or copolymer containing quaternary ammonium groups, a polymer or copolymer containing at least one of guanidinium or thiuronium groups a polymer or copolymer containing imidazolium groups, a polymer or copolymer containing pyridinium groups. The polymer may be a mixture of ionomer resin and ion exchange resin.

In some embodiments, the amount of polymer contained in the electrode, on a weight basis, may be from about 1 to about 95 percent, from about 5 to about 95 percent, from about 10 to about 95 percent, from about 20 to about 95 percent, from about 30 to about 95 percent, from about 1 to about 90 percent, from about 5 to about 90 percent, from about 10 to about 90 percent, from about 20 to about 90 percent, from about 30 to about 90 percent, from about 1 to about 75 percent, from about 5 to about 75 percent, from about 10 to about 75 percent, from about 20 to about 75 percent, from about 30 to about 75 percent, from about 1 to about 70 percent, from about 5 to about 70 percent, from about 10 to about 70 percent, from about 20 to about 70 percent, from about 30 to about 70 percent, from about 1 to about 60 percent, from about 5 to about 60, from about 10 to about 60 percent, from about 20 to about 60 percent, from about 30 to about 60 percent, from about 1 to about 50 percent, 5 to about 50 percent, from about 10 to about 50 percent, from about 20 to about 50 percent, from about 30 to about 50 percent, from about 1 to about 40 percent, 5 to about 40 percent, from about 10 to about 40 percent, from about 20 to about 40 percent, or even from about 30 to about 40 percent.

In some embodiments, the electrodes of the present disclosure may contain a non-electrically conductive, inorganic particulate. Non-electrically conductive, inorganic particulate include, but is not limited to, minerals and clays known in the art. In some embodiments the non-electrically conductive inorganic particulate may be a metal oxide. In some embodiments the non-electrically conductive, inorganic particulate include at least one of silica, alumina, titania, and zirconia.

The polymer and electrically conductive particulate are fabricated into a porous electrode by mixing the polymer and electrically conductive particulate to form an electrode blend, i.e. a porous electrode material, coating the electrode blend onto a substrate and providing at least one of a fusing, curing, polymerizing and drying treatment to form an electrode, wherein the electrode is porous. The porous electrode may be in the form of a sheet. After drying or during drying, the temperature may be such that the temperature is near, at or above the softening temperature of the polymer, e.g. the glass transition temperature and/or the melting temperature of the polymer, which may aid in the adhering of carbon particulate to the polymer and/or further fuse the polymer.

In one embodiment, polymer particulate and electrically conductive carbon particulate may be mixed together as dry components, forming a dry blend. Milling media, e.g. milling beads may, be added to the dry blend to facilitate the mixing process and/or to at least partially embed the electrically conductive carbon particulate into the surface of the polymer particulate. The dry blend may then be coated, using conventional techniques, including but not limited to knife coating and electrostatic coating, on a substrate, e.g. a liner or release liner. The coating may then be heat treated at temperatures near, at or above the softening temperature of the polymer particulate, e.g. the glass transition temperature and/or the melting temperature of the polymer particulate, to fuse at least a portion of the polymer particulate/carbon particulate dry blend into a unitary, porous material, thereby forming a porous electrode. The porous electrode may be in the form of a sheet. The thermal treatment may also aid in adhering the electrically conductive carbon particulate to the surface of the polymer particulate. The thermal treatment may be conducted under pressure, e.g. in a heated press or between heated rolls. The press and or heated rolls may be set to provide a specific desired gap, which will facilitate obtaining a desired electrode thickness. The dry coating and fusing processes may be combined into a single step using a roll coating technique, wherein the rolls are set at a desired gap, correlated to the desired electrode thickness, and the rolls are also heated to the desired fusing temperature, thus coating and thermal treatment is conducted simultaneously.

In an alternative embodiment, the dry blend or the individual particulates may be added to an appropriate liquid medium, i.e. a solvent, and mixed, using conventional techniques, e.g. blade mixing or other agitation, forming a polymer particulate/carbon particulate dispersion. Milling media, e.g. milling beads, may be added to the dispersion to facilitate the mixing process and/or to at least partially embed the electrically conductive carbon particulate into the surface of the polymer particulate. If milling media is employed, agitation is usually achieved by shaking or rolling the container holding the dry blend. The dispersion may be coated on a substrate, e.g. a liner or release liner, using conventional techniques, e.g. knife coating. The coating may then be dried, via heat treatment at elevated temperatures, to remove the liquid medium and to fuse at least a portion of the polymer particulate/carbon particulate blend into a unitary, porous material, thereby forming a porous electrode. The porous electrode may be in the form of a sheet. The thermal treatment may also aid in adhering the electrically conductive carbon particulate to the surface of the polymer particulate. The heat treatment used to dry the dispersion, i.e. evaporate the liquid medium, and to fuse at least a portion of the polymer particulate may be at the same or different temperatures. Vacuum may be used to remove the liquid medium or aid in the removal of the liquid medium. In another embodiment, the polymer particulate may be obtained as a dispersion, e.g. the dispersion resulting from a suspension or emulsion polymerization, and the electrically conductive carbon particulate may be added to this dispersion. Mixing, coating, drying and fusing may be conducted as described above.

In yet another alternative embodiment, the dry blend or the individual particulates may be added to an appropriate liquid medium, i.e. polymer precursor liquid, and mixed, using conventional techniques, e.g. blade mixing or other agitation, forming a polymer particulate/carbon particulate dispersion. Milling media, e.g. milling beads, may be added to the dispersion to facilitate the mixing process and/or to at least partially embed the electrically conductive carbon particulate into the surface of the polymer particulate. If milling media is employed, agitation is usually achieved by shaking or rolling the container holding the dispersion. The dispersion may be coated on a substrate, e.g. a liner or release liner, using conventional techniques, e.g. knife coating. The coating may then be at least one of dried, cured, polymerized and fused, forming a binder resin and transforming at least a portion of the polymer particulate/carbon particulate blend into a unitary, porous material, thereby forming a porous electrode. The porous electrode may be in the form of a sheet. If thermal treatment is used to form the polymer binder resin or a secondary thermal treatment is applied to the polymer binder resin, the temperature may be such that the temperature is near, at or above the softening temperature of the polymer binder resin, e.g. the glass transition temperature and/or the melting temperature of the polymer binder resin, which may aid in the adhering of carbon particulate to the binder resin and/or further fuse the binder resin.

In another embodiment, an electrically conductive carbon particulate may be dispersed in a polymer precursor liquid and mixed using conventional techniques, e.g. blade mixing or other agitation. Milling media, e.g. milling beads, may be added to the dispersion to facilitate the mixing process. If milling media is employed, agitation is usually achieved by shaking or rolling the container holding the dispersion. The resulting dispersion may be coated on a substrate, e.g. a liner or release liner, using conventional techniques, e.g. knife coating. The polymer precursor liquid coating may then be at least one of dried, cured, polymerized and fused, forming a binder resin and a corresponding unitary, porous material, i.e. a porous electrode. The porous electrode may be in the form of a sheet. If a thermal treatment is used to form the polymer binder rein or a secondary thermal treatment is applied to the polymer binder resin, the temperature may be such that the temperature is near, at or above the softening temperature of the polymer binder resin, e.g. the glass transition temperature and/or the melting temperature of the polymer binder resin, which may aid in the adhering of carbon particulate to the binder resin and/or further fuse the binder resin.

In some embodiments, the polymer precursor liquid is a polymer solution, e.g. at least one polymer dissolved in at least one solvent, and the electrically, conductive carbon particulate is dispersed in the polymer solution. Milling media, e.g. milling beads, may be added to the dispersion to facilitate the mixing process. The resulting dispersion may be coated on a substrate, e.g. a liner or release liner, using conventional techniques, e.g. knife coating. The dispersion coating may be dried, forming a polymer binder resin and a corresponding, unitary, porous material, i.e. a porous electrode. The porous electrode may be in the form of a sheet. After drying or during drying, the temperature may be such that the temperature is near, at or above the softening temperature of the polymer binder resin, e.g. the glass transition temperature and/or the melting temperature of the polymer binder resin, which may aid in the adhering of carbon particulate to the binder resin and/or further fuse the binder resin.

The solvent used in the polymer solution is not particularly limited, except that the polymer that will form the polymer binder resin must be soluble in it. The solvent may be selected based on the chemical structure of the polymer and the solubility of the polymer in the solvent. The optional solvent used in the reactive polymer precursor liquid is not particularly limited, except that the at least one of a liquid monomer and a liquid oligomer is soluble in the solvent. Useful solvents include, but are not limited to, water, alcohols (e.g. methanol, ethanol and propanol), acetone, ethyl acetate, alkyl solvents (e.g. pentane, hexane, cyclohexane, heptane and octane), methyl ethyl ketone, ethyl ethyl ketone, dimethyl ether, petroleum ether, toluene, benzene, xylenes, dimethylformamide, dimethylsulfoxide, chloroform, carbon tetrachloride, chlorobenzene and mixtures thereof.

In some embodiments, the polymer precursor liquid is a reactive polymer precursor liquid, e.g. at least one of a liquid monomer and a liquid oligomer, and the electrically conductive carbon particulate is dispersed in the reactive polymer precursor solution. The reactive polymer precursor may optionally include at least one solvent and may optionally include at least one polymer that soluble in the liquid components of the reactive polymer precursor liquid. Milling media, e.g. milling beads, may be added to the dispersion to facilitate the mixing process. The resulting dispersion may be coated on a substrate, e.g. a liner or release liner, using conventional techniques, e.g. knife coating. The reactive polymer precursor liquid coating may then be at least one of dried, cured, polymerized and fused, forming a polymer binder resin and a corresponding unitary, porous material, i.e. a porous electrode. The porous electrode may be in the form of a sheet. If a thermal treatment is used to form the polymer binder rein or a secondary thermal treatment is applied to the polymer binder resin, the temperature may be such that the temperature is near, at or above the softening temperature of the polymer binder resin, e.g. the glass transition temperature and/or the melting temperature of the polymer binder resin, which may aid in the adhering of carbon particulate to the binder resin and/or further fuse the binder resin.

When the polymer precursor liquid is a reactive polymer precursor liquid, the reactive polymer precursor liquid may include appropriate additives to aid in the curing and/or polymerization of the reactive polymer precursor liquid. Additives include, but are not limited to catalysts, initiators, curatives, inhibitors, chain transfer agents and the like. Curing and/or polymerization may be conducted by at least one of thermal and radiation. Radiation may include actinic radiation, including UV and visible radiation. Upon curing, the reactive polymer precursor liquid may form a B-stage polymer binder resin, i.e. capable of a second step cure. If B-stageable polymer binder resins are desired, the first cure may be a thermal cure, and the second cure may be a radiation cure, both curing steps may be thermal cure, for example, at two different cure temperatures, both cures may be radiation cure, at two different wavelengths, or the first cure may be a radiation cure and the second cure a thermal cure.

The substrates of the present disclosure are not particularly limited and may include conventional liners and release liners, e.g. polymer films that may or may not have a low surface energy coating. The polymer of the substrate may be at least one of a thermoplastic polymer and a thermoset polymer. Thermoplastic polymers, include, but are to limited to, polyalkylenes; e.g. polyethylene and polypropylene; polyurethane; polyamide; polycarbonates; polysulfones; polystrenes; polyester, e.g. polyethylene terephthalate and polybutylene terephthalate; polybutadiene; polyisoprene; polyalkylene oxides, e.g. polyethylene oxide; ethylene vinyl acetate; cellulose acetate; ethyl cellulose and block copolymers of any of the proceeding polymers. Thermoset polymers include, but are not limited to, polyimide, polyurethanes, polyesters, epoxy resins, phenol-formaldehyde resins, urea formaldehyde resins and rubber. In some embodiments, the substrate is a dielectric polymer, substrate. The polymer of the substrate may be a polymer blend. The substrate may include holes or pores. The holes or pores may be filled with the dispersions and a porous electrode material may be formed therein. In these embodiments, the substrate may become part of the electrode, as the holes or pores containing the porous electrode material allow electrical communication from one major surface of the electrode to its opposed major surface. The substrate may include topography, and the porous electrodes may conform to the topography, forming the same general topography of the substrate. In some embodiments, the substrate of the porous electrode may include at least one precisely shaped topographical feature. In some embodiments, the substrate of the porous electrode may include a plurality of precisely shaped topographical features. “Precisely shaped” refers to a topographical feature, having a molded shape that is the inverse shape of a corresponding mold cavity, said shape being retained after the topographical feature is removed from the mold. A precisely shaped topographical feature may still be considered precisely shaped, even though it may undergo some shrinkage related to curing, drying or other thermal treatments, as it retains the general shape of the mold cavity from which it was originally produced. The at least one precisely shaped topographical feature may be made by a precision fabrication processes known in the art, e. g. molding and/or embossing. In some embodiments, the topography of the film substrate may include one or more channels. In some embodiments, at least a portion of the channels are interconnected. In some embodiments, at least a portion of the holes are included in the topography, e.g. in the channels. In some embodiments, all of the holes are included in the topography, e.g. in the channels. In some embodiments, the porous electrode material may fill the topography, producing a porous electrode material with the negative image of the substrate topography. The depth and/or height of the topography may be limited by the thickness of the substrate. In some embodiments, the depth and/or height of the topography is less than the thickness of the substrate.

In some embodiments, the substrate may be a conductive substrate, e.g. a conductive metal including but not limited to at least one of gold, silver, and aluminum. In some embodiments, the electrode is removed from the conductive substrate. In some embodiments, the electrode may include the conductive substrate. In these embodiments, the conductive substrate may act as a current collector, and replace the current collector within an electrochemical cell or may be positioned adjacent a current collector in a typical liquid flow cell.

The electrodes of the present disclosure may be washed using conventional techniques to remove loose carbon particulate. The washing technique may include and appropriate solvent, e.g. water, and/or surfactant to aid in the removal of loose carbon particulate. The electrodes of the present disclosure may be made by a continuous roll to roll process, the electrode sheet being wound to form a roll good.

In some embodiments, the electrode may be hydrophilic. This may be particularly beneficial when the porous electrode is to be used in conjunction with aqueous anolyte and/or catholyte solutions. Uptake of a liquid, e.g. water, catholyte and/or anolyte, into the pores of a liquid flow battery electrode may be considered a key property for optimal operation of a liquid flow battery. In some embodiments, 100 percent of the pores of the electrode may be filled by the liquid, creating the maximum interface between the liquid and the electrode surface. In other embodiments, between about 30 percent and about 100 percent, between about 50 percent and about 100 percent, between about 70 percent and about 100 percent or even between about 80 percent and 100 percent of the pores of the electrode may be filled by the liquid. In some embodiments the porous electrode may have a surface contact angle with water, catholyte and/or anolyte of less than 90 degrees. In some embodiments, the microporous protection layer may have a surface contact with water, catholyte and/or anolyte of between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees.

In some embodiments, the electrode may be surface treated to enhance the wettability of the electrode to a given anolyte or catholyte or to provide or enhance the electrochemical activity of the electrode relative to the oxidation-reduction reactions associated with the chemical composition of a given anolyte or catholyte. Surface treatments include, but are not limited to, at least one of chemical treatments, thermal treatments and plasma treatments.

Surfactants may be used in the electrode dispersion/coating solutions, for example, to improve wetting and/or aid in dispersing of the electrically conductive carbon particulate. Surfactants may include cationic, anionic and nonionic surfactants. Surfactants useful in the electrode dispersion/coating solutions include, but are not limited to TRITON X-100, available from Dow Chemical Company, Midland, Mich.; DISPERSBYK 190, available from BYK Chemie GMBH, Wesel, Germany; amines, e.g. olyelamine and dodecylamine; amines with more than 8 carbons in the backbone, e.g. 3-(N, N-dimethyldodecylammonio) propanesulfonate (SB12); SMA 1000, available from Cray Valley USA, LLC, Exton, Pa.; 1,2-propanediol, triethanolamine, dimethylaminoethanol; quaternary amine and surfactants disclosed in U.S. Pat. Publ. No. 20130011764, which is incorporated herein by reference in its entirety. If one or more surfactants are used in the dispersions/coating solutions, the surfactant may be removed from the electrode by a thermal process, wherein the surfactant either volatilizes at the temperature of the thermal treatment or decomposes and the resulting compounds volatilize at the temperature of the thermal treatment. In some embodiments, the electrode is substantially free of surfactant. By “substantially free” it is meant that the electrodes contains, by weight, from 0 percent to 0.5 percent, from 0 percent to 0.1 percent, from 0 percent to 0.05 percent or even from 0 percent to 0.01 percent surfactant. In some embodiments, the electrode layer contains no surfactant. The surfactant may be removed from the electrode by washing or rinsing with a solvent of the surfactant. Solvents include, but are not limited to water, alcohols (e.g. methanol, ethanol and propanol), acetone, ethyl acetate, alkyl solvents (e.g. pentane, hexane, cyclohexane, heptane and octane), methyl ethyl ketone, ethyl ethyl ketone, dimethyl ether, petroleum ether, toluene, benzene, xylenes, dimethylformamide, dimethylsulfoxide, chloroform, carbon tetrachloride, chlorobenzene and mixtures thereof.

The thickness of the electrode may be from about 10 microns to about 5000 microns, from about 10 microns to about 1000 microns, from about 10 microns to about 500 microns, from about 10 microns to about 250 microns, from about 10 microns to about 100 microns, from about 25 microns to about 5000 microns, from about 25 microns to about 1000 microns, from about 25 microns to about 500 microns, from about 25 microns to about 250 microns, or even from about 25 microns to about 100 microns. The porosity of the porous electrodes, on a volume basis, may be from about 5 percent to about 95 percent, from about 5 percent to about 90 percent, from about 5 percent to about 80 percent, from about 5 percent to about 70 percent, from about 10 percent to about 95 percent, from about 10 percent to 90 percent, from about 10 percent to about 80 percent, from about 10 percent to about 70 percent, from about 10 percent to about 70 percent, from about 20 percent to about 95 percent, from about 20 percent to about 90 percent, from about 20 percent to about 80 percent, from about 20 percent to about 70 percent, from about 20 percent to about 70 percent, from about 30 percent to about 95 percent, from about 30 percent to about 90 percent, from about 30 percent to about 80 percent, or even from about 30 percent to about 70 percent.

The electrode may be a single layer or multiple layers. When the porous electrode includes multiple layers, there is no particular limit as to the number of layers that may be used. However, as there is a general desire to keep the thickness of electrode and membrane assembly as thin as possible, the electrode may include from about 2 to about 20 layers, from about 2 to about 10 layers, from about 2 to about 8 layer, from about 2 to about 5 layers, from about 3 to about 20 layers, from about 3 to about 10 layers, from about 3 to about 8 layers, or even from about 3 to about 5. In some embodiments, when the electrode includes multiple layers, the electrode material of each layer may be the same electrode material, i.e. the composition of the electrode material of each layer is the same. In some embodiments, when the electrode includes multiple layers, the electrode material of at least one, up to including all of the layers, may be different, i.e. the composition of the electrode material of at least one, up to and including all layers, differs from the composition of the electrode material of another layer.

The porous electrodes of the present disclosure may have an electrical resistivity of from about 0.1 μOhm m to about 10000 μOhm m, from about 1 μOhm m to about 10000 μOhm m, from 10 μOhm m to about 10000 μOhm m, from about 0.1 μOhm m to about 1000 μOhm m, from about 1 μOhm m to about 1000 μOhm m, from 10 μOhm m to about 1000 μOhm m, from about 0.1 μOhm m to about 100 μOhm m, from about 1 μOhm m to about 100 μOhm m, or even from 10 μOhm m to about 100 μOhm m.

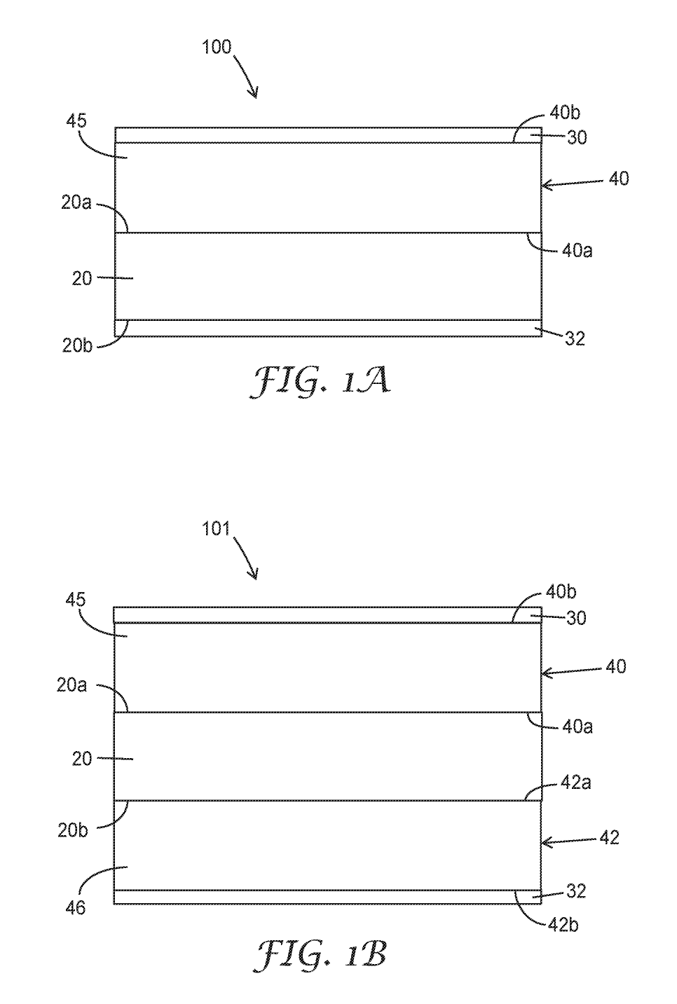

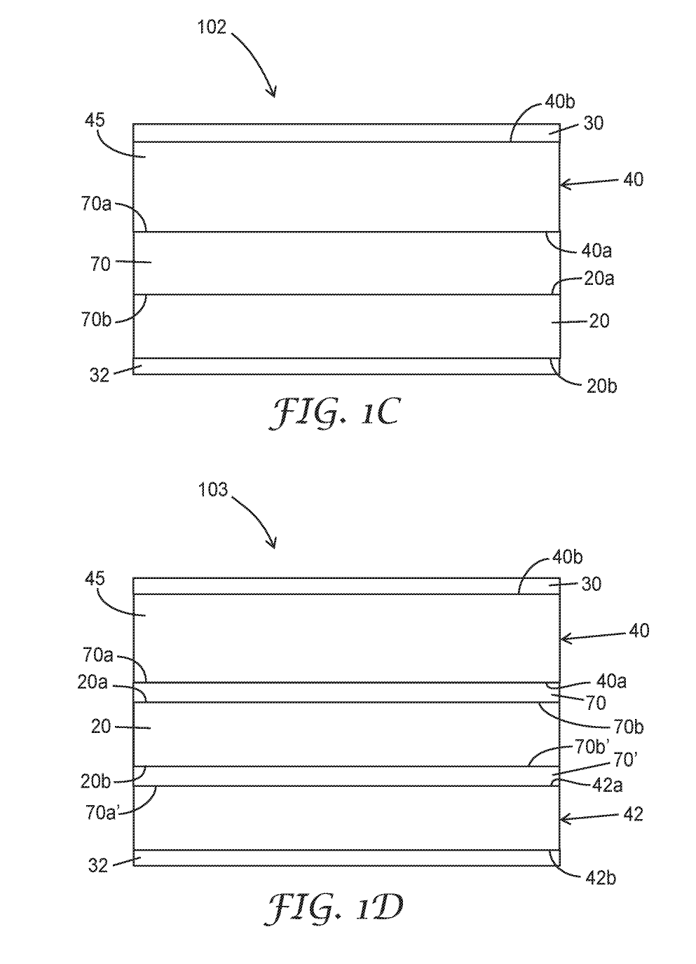

In another embodiment, of the present disclosure, the porous electrodes of the present disclosure may be used to form membrane-electrode assemblies, for use in, for example, liquid flow batteries. A membrane-electrode assembly includes an ion exchange membrane, having a first surface and an opposed second surface, and a porous electrode according to any one of the embodiments of the present disclosure, wherein a major surface of the porous electrode is adjacent the first surface of the ion exchange membrane. In some embodiments a major surface of the porous electrode is proximate the first surface of the ion exchange membrane. In some embodiments a major surface of the porous electrode is in contact with the first surface of the ion exchange membrane. The membrane-electrode assembly may further include a second porous electrode, having a first major surface and a second major surface, according to any one of the porous electrodes of the present disclosure, wherein a major surface of the second porous electrode is adjacent the opposed second surface of the ion exchange membrane. Several specific, but non-limiting, embodiments of the membrane-electrode assemblies of the present disclosure are shown in FIGS. 1A-1D.

FIG. 1A shows a schematic cross-sectional side view of a membrane-electrode assembly 100 including a first porous electrode 40 having a first major surface 40a and an opposed second major surface 40b and includes porous electrode material 45; and a first on exchange membrane 20 having a first surface 20a and an opposed second surface 20b. In some embodiments, first major surface 40a of first porous electrode 40 is adjacent first surface 20a of the ion exchange membrane 20. In some embodiments, first major surface 40a of first porous electrode 40 is proximate first surface 20a of the ion exchange membrane 20. In some embodiments, first major surface 40a of first porous electrode 40 is in contact with first surface 20a of the ion exchange membrane 20. Electrode assembly 100 may further include one or more optional release liners 30, 32. The optional release liners 30 and 32 may remain with the membrane-electrode assembly until it is used in a cell or battery, in order to protect the outer surfaces of the ion exchange membrane and electrode from dust and debris. The release liners may also provide mechanical support and prevent tearing of the ion exchange membrane and electrode and/or marring of their surfaces, prior to fabrication of the membrane-electrode assembly. Conventional release liners known in the art may be used for optional release liners 30 and 32.

FIG. 1B shows another embodiment of a membrane-electrode assembly 101 and is similar to the membrane-electrode assembly of FIG. 1A, and further includes a second porous electrode 42 having a first major surface 42a and an opposed second major surface 42b and includes porous electrode material 46. Porous electrode material 46 may be the same as porous electrode material 45 or may be different. In some embodiments, the first major surface 42a of second porous electrode 42 is adjacent second surface 20b of ion exchange membrane 20. In some embodiments, the first major surface 42a of second porous electrode 42 is proximate second surface 20b of ion exchange membrane 20. In some embodiments, the first major surface 42a of second porous electrode 42 is in contact with second surface 20b of the ion exchange membrane 20.

The membrane-electrode assemblies of the present disclosure include an ion exchange membrane (element 20, of FIGS. 1A and 1B). Ion exchange membranes known in the art may be used. Ion exchange membranes are often referred to as separators and may be prepared from ion exchange resins, for example, those previously discussed for the polymer of the porous electrode material of the porous polymer. In some embodiments, the ion exchange membranes may include a fluorinated ion exchange resin. Ion exchange membranes useful in the embodiments of the present disclosure may be fabricated from ion exchange resins known in in the art or be commercially available as membrane films and include, but are not limited to, NAFION PFSA MEMBRANES, available from DuPont, Wilmington, Del.; AQUIVION PFSA, a perfluorosulfonic acid, available from SOLVAY, Brussels, Belgium; FLEMION and SELEMION, fluoropolomer ion exchange membranes, available from Asahi Glass, Tokyo, Japan; FUMASEP ion exchange membranes, including FKS, FKB, FKL, FKE cation exchange membranes and FAB, FAA, FAP and FAD anionic exchange membranes, available from Fumatek, Bietigheim-Bissingen, Germany and ion exchange membranes and materials described in U.S. Pat. No. 7,348,088, incorporated herein by reference in its entirety. The ion exchange resins useful in the fabrication of the ion exchange membrane may be the ion exchange resin previously disclosed herein with respect to the polymer of the electrode.

The ion exchange membranes of the present disclosure may be obtained as free standing films from commercial suppliers or may be fabricated by coating a solution of the appropriate ion exchange membrane resin in an appropriate solvent, and then heating to remove the solvent. The ion exchange membrane may be formed from an ion exchange membrane coating solution by coating the solution on a release liner and then drying the ion exchange membrane coating solution coating to remove the solvent. The first surface of the resulting ion exchange membrane can then be laminated to a first surface of a porous electrode using conventional lamination techniques, which may include at least one of pressure and heat, forming membrane-electrode assembly as shown in FIG. 1A. A first major surface 42a of a second porous electrode 42 may then be laminated to the second surface 20b of the ion exchange membrane 20, forming a membrane-electrode assembly 101, as shown in FIG. 1B. The optional release liners 30, 32 may remain with the assembly until it is used to fabricate a membrane-electrode assembly, in order to protect the outer surface of the electrode from dust and debris. The release liners may also provide mechanical support and prevent tearing of electrode and/or marring of its surface, prior to fabrication of the membrane-electrode assembly. The ion exchange membrane coating solution may be coated directly on a surface of an electrode. The ion exchange membrane coating solution coating is then dried to form an ion exchange membrane and the corresponding membrane-electrode assembly, FIG. 1A. If a second electrode is laminated or coated on the exposed surface of the formed ion exchange membrane, a membrane-electrode assembly with two electrodes may be formed, see FIG. 1B. In another embodiment, the ion exchange membrane coating solution may be coated between two electrodes and then dried to form a membrane-electrode assembly.

Any suitable method of coating may be used to coat the ion exchange membrane coating solution on either a release liner or an electrode. Typical methods include both hand and machine methods, including hand brushing, notch bar coating, fluid bearing die coating, wire-wound rod coating, fluid bearing coating, slot-fed knife coating, and three-roll coating. Most typically three-roll coating is used. Advantageously, coating is accomplished without bleed-through of the ion exchange membrane coating from the coated side of the electrode to the uncoated side. Coating may be achieved in one pass or in multiple passes. Coating in multiple passes may be useful to increase coating weight without corresponding increases in cracking of the ion exchange membrane.

The amount of solvent, on a weight basis, in the ion exchange membrane coating solution may be from about 5 to about 95 percent, from about 10 to about 95 percent, from about 20 to about 95 percent, from about 30 to about 95 percent, from about 40 to about 95 percent, from about 50 to about 95 percent, from about 60 to about 95 percent, from about 5 to about 90 percent, from about 10 to about 90 percent, from about 20 percent to about 90 percent, from about 30 to about 90 percent, from about 40 to about 90 percent, from about 50 to about 90 percent, from about 60 to about 90 percent, from about 5 to about 80 percent, from about 10 to about 80 percent from about 20 percent to about 80 percent, from about 30 to about 80 percent, from about 40 to about 80 percent, from about 50 to about 80 percent, from about 60 to about 80 percent, from about 5 percent to about 70 percent, from about 10 percent to about 70 percent, from about 20 percent to about 70 percent, from about 30 to about 70 percent, from about 40 to about 70 percent, or even from about 50 to about 70 percent.

The amount of ion exchange resin, on a weight basis, in the ion exchange membrane coating solution may be from about 5 to about 95 percent, from about 5 to about 90 percent, from about 5 to about 80 percent, from about 5 to about 70 percent, from about 5 to about 60 percent, from about 5 to about 50 percent, from about 5 to about 40 percent, from about 10 to about 95 percent, from about 10 to about 90 percent, from about 10 to about 80 percent, from about 10 to about 70 percent, from about 10 to about 60 percent, from about 10 to about 50 percent, from about 10 to about 40 percent, from about 20 to about 95 percent, from about 20 to about 90 percent, from about 20 to about 80 percent, from about 20 to about 70 percent, from about 20 to about 60 percent, from about 20 to about 50 percent, from about 20 to about 40 percent, from about 30 to about 95 percent, from about 30 to about 90 percent, from about 30 to about 80 percent, from about 30 to about 70 percent, from about 30 to about 60 percent, or even from about 30 to about 50 percent.

The electrodes, membranes, e.g. ion exchange membranes, membrane-electrode assemblies and the electrochemical cells and liquid flow batteries of the present disclosure may include one or more microporous protection layers. Microporous protection layers are layers that may be coated or laminated on at least one of the electrode and membrane or may be place between the membrane and electrode for the purpose of preventing puncture of the membrane by the materials of the electrode. By preventing puncture of the membrane by the conductive electrode, the corresponding localized shorting of a cell or battery may be prevented. Microporous protection layers are disclosed in U.S. Provisional Patent Application Ser. No. 62/137,504, entitled “Membrane Assemblies, Electrode Assemblies, Membrane-Electrode Assemblies and Electrochemical Cells and Liquid Flow Batteries Therefrom”, which is hereby incorporated herein by reference in its entirety.

The membrane-electrode assemblies of the present disclosure may further include a microporous protection layer disposed between the porous electrode and the ion exchange membrane. In some embodiments, in membrane-electrode assemblies that include a first porous electrode and a second porous electrode, the membrane-electrode assembly may further include a first microporous protection layer disposed between the ion exchange membrane and the first porous electrode and a second microporous protection layer disposed between the ion exchange membrane and the second porous electrode. The microporous protection layers may comprises a polymer resin and an electrically conductive carbon particulate and, optionally, a non-electrically conductive particulate. The composition of the microporous protection layer differs from the composition of the porous electrodes. In some embodiments, the polymer resin of the first microporous protection layer and second microporous protection layer, if present, includes an ionic resin. Several specific, but non-limiting, embodiments of the membrane-electrode assemblies of the present disclosure are shown in FIGS. 1C and 1D.

FIG. 1C shows a schematic cross-sectional side view of membrane-electrode assembly 102 which is similar to the membrane electrode assembly of FIG. 1A, as previously described, and further includes a first microporous protection layer 70, having a first major surface 70a and a second major surface 70b, disposed between the ion exchange membrane 20 and the first porous electrode 40. The first microporous protection layer may comprise a polymer resin and an electrically conductive carbon particulate and, optionally, a non-electrically conductive particulate. In some embodiments, the polymer resin of the first microporous protection layer is an ionic resin.

FIG. 1D shows a schematic cross-sectional side view of membrane-electrode assembly 103 which is similar to the membrane electrode assembly of FIG. 1C, as previously described, and further includes a second microporous protection layer 70′, having a first major surface 70′a and a second major surface 70′b, disposed between the ion exchange membrane 20 and the second porous electrode 42. The second microporous protection layer may comprise a polymer resin and an electrically conductive carbon particulate and, optionally, a non-electrically conductive particulate. In some embodiments, the polymer resin of the second microporous protection layer is an ionic resin. In some embodiments the composition of the first microporous protection layers is the same as the composition of the second microporous protection layer. In some embodiments the composition of the first microporous protection layers is different from the composition of the second microporous protection layer.

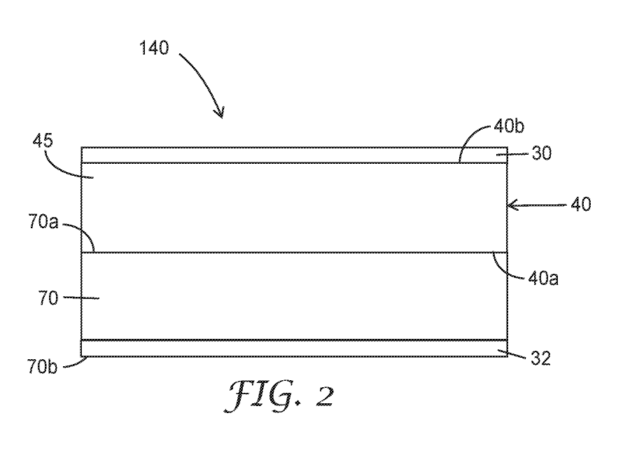

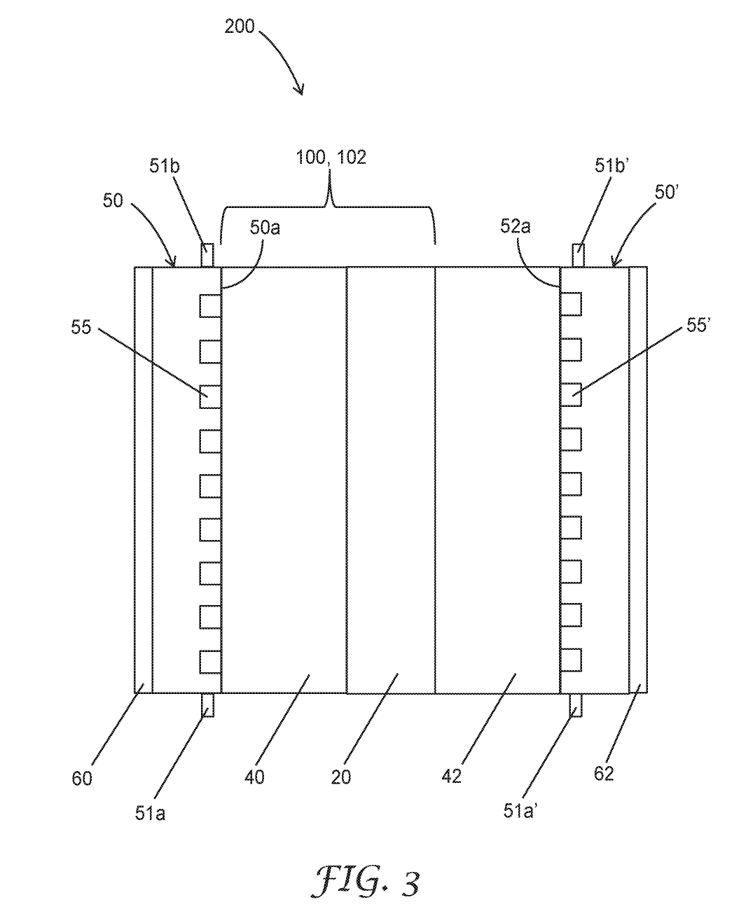

The present disclosure further provides an electrode assembly for a liquid flow battery. The electrode assembly includes a first porous electrode according to any one of the porous electrodes of the present disclosure and a first microporous protection layer. The first electrode includes a first major surface and an opposed second major surface, and the first microporous protection layer includes a first surface and an opposed second surface. A major surface of the first porous electrode is adjacent, proximate or in contact with the second surface of the first microporous protection layer. In some embodiments, the first major surface of the first porous electrode is adjacent, proximate or in contact with the second surface of the first microporous protection layer. In some embodiments, the second major surface of the first porous electrode is adjacent, proximate or in contact with the second surface of the first microporous protection layer. In some embodiments, the first microporous protection layer comprises a polymer resin and an electrically conductive carbon particulate and, optionally, a non-electrically conductive particulate. The composition of the microporous protection layer differs from the composition of the porous electrode. In some embodiments, the polymer resin of the first microporous protection is an ionic resin, the ionic resin may be as previously described with respect to the ionic resin of the polymer of the porous electrode material. A specific, but non-limiting, embodiment of an electrode assembly of the present disclosure is shown in FIG. 2.

Referring to FIG. 2, a schematic cross-sectional side view of an exemplary electrode assembly according to one embodiment of the present disclosure, electrode assembly 140 includes a first porous electrode 40 as previously described and a first microporous protection layer 70 having a first surface 70a and an opposed second surface 70b. In some embodiments, the first major surface 40a of the first porous electrode 40 is adjacent first surface 70a of the first microporous protection layer 70. In some embodiments, the first major surface 40a of the first porous electrode 40 is proximate the first surface 70a of the first microporous protection layer 70. In some embodiments, the first major surface 40a of the first porous electrode 40 is in contact with first surface 70a of the first microporous protection layer 70. In some embodiments, the first microporous protection layer 70 comprises a polymer resin and an electrically conductive carbon particulate and, optionally, a non-electrically conductive particulate.

The electrically conductive carbon particulate of the microporous protection layer may be at least one of include particles, flakes, fibers, dendrites and the like. These particulates types have previously been defined with respect to both an electrically conductive carbon particulate and a polymer particulate and the same definition is use for electrically conductive carbon particulate of the microporous protection layer. Electrically conductive particulate of the microporous protection layers may include metals, metalized dielectrics, e.g. metalized polymer particulates or metalize glass particulates, conductive polymers and carbon, including but not limited to, glass like carbon, amorphous carbon, graphene, graphite, carbon nanotubes and carbon dendrites, e.g. branched carbon nanotubes, for example carbon nanotrees. Electrically conductive particulate of the microporous protection layer may include semi-conductor materials, e.g. BN, AN and SiC. In some embodiments, the microporous protection layer is free of metal particulate.

In some embodiments, the electrically conductive particulate of the microporous protection layer may be surface treated to enhance the wettability of the microporous protection layer to a given anolyte or catholyte or to provide or enhance the electrochemical activity of the microporous protection layer relative to the oxidation-reduction reactions associated with the chemical composition of a given anolyte or catholyte. Surface treatments include, but are not limited to, at least one of chemical treatments, thermal treatments and plasma treatments. In some embodiments, the electrically conductive particulate of the microporous protection layer is hydrophilic.

In some embodiments, the amount of electrically conductive particulate contained in the resin of the microporous protection layer, on a weight basis, may be from about 5 to about 95 percent, from about 5 to about 90 percent, from about 5 to about 80 percent, from about 5 to about 70 percent, from about 10 to about 95 percent, from about 10 to about 90 percent, from about 10 to about 80 percent, from about 10 to about 70 percent, 25 to about 95 percent, from about 25 to about 90 percent, from about 25 to about 80 percent, from about 25 to about 70 percent, from about 30 to about 95 percent, from about 30 to about 90 percent, from about 30 to about 80 percent, from about 30 to about 70 percent, 40 to about 95 percent, from about 40 to about 90 percent, from about 40 to about 80 percent, from about 40 to about 70 percent, 50 to about 95 percent, from about 50 to about 90 percent, from about 10 to about 80 percent, or even from about 50 to about 70 percent.

Non-electrically conductive particulate of the microporous protection layer include, but is not limited to non-electrically conductive inorganic particulate and non-electrically conductive polymeric particulate. In some embodiments, the non-electrically conductive particulate of the microporous protection layer comprises a non-electrically conductive inorganic particulate. Non-electrically conductive inorganic particulate include, but is not limited to, minerals and clays known in the art. In some embodiments the non-electrically conductive inorganic particulate include at least one of silica, alumina, titania, and zirconia. In some embodiments, the non-electrically conductive particulate may be ionically conductive, e.g. a polymeric ionomer. In some embodiments, the non-electrically conductive particulate comprises a non-electrically conductive polymeric particulate. In some embodiments, the non-electrically conductive polymeric particulate is a non-ionic polymer, i.e. a polymer free of repeat units having ionic functional groups. Non-electrically conductive polymers include, but are not limited to, epoxy resin, phenolic resin, polyurethanes, urea-formadehyde resin, melamine resin, polyesters, polyamides, polyethers, polycarbonates, polyimides, polysulphones, polyphenylene oxides, polyacrylates, polymethacylates, polyolefin, e.g. polyethylene and polypropylene, styrene and styrene based random and block copolymers, e.g. styrene-butadiene-styrene, polyvinyl chloride, and fluorinated polymers, e.g. polyvinylidene fluoride and polytetrafluoroethylene. In some embodiments, the non-electrically conducive particulate is substantially free of a non-electrically conductive polymeric particulate. By substantially free it is meant that the non-electrically conductive particulate contains, by weight, between about 0% and about 5%, between about 0% and about 3%, between about 0% and about 2%, between about 0% and about 1%, or even between about 0% and about 0.5% of a non-electrically conductive polymeric particulate.

In some embodiments, the amount of non-electrically conductive particulate contained in the resin of the microporous protection layer, on a weight basis, may be from about 1 to about 99 percent, from about 1 to about 95 percent, from about 1 to about 90 percent, from about 1 to about 80 percent, from about 1 to about 70 percent, from about 5 to about 99 percent, from about 5 to about 95 percent, from about 5 to about 90 percent, from about 5 to about 80 percent, from about 5 to about 70 percent, from about 10 to about 99 percent, from about 10 to about 95 percent, from about 10 to about 90 percent, from about 10 to about 80 percent, from about 10 to about 70 percent, from about 25 to about 99 percent, from about 25 to about 95 percent, from about 25 to about 90 percent, from about 25 to about 80 percent, from about 25 to about 70 percent, from about 30 to 99 percent, from about 30 to about 95 percent, from about 30 to about 90 percent, from about 30 to about 80 percent, from about 30 to about 70 percent, from about 40 to about 99 percent, from about 40 to about 95 percent, from about 40 to about 90 percent, from about 40 to about 80 percent, from about 40 to about 70 percent, from about 50 to 99 percent, from about 50 to about 95 percent, from about 50 to about 90 percent, from about 10 to about 80 percent, or even from about 50 to about 70 percent.

In some embodiments, the amount of electrically conductive particulate and non-electrically conductive particulate, i.e. the total amount of particulate, contained in the resin of the microporous protection layer, on a weight basis, may be from about 1 to about 99 percent, from about 1 to about 95 percent, from about 1 to about 90 percent, from about 1 to about 80 percent, from about 1 to about 70 percent, from about 5 to about 99 percent, from about 5 to about 95 percent, from about 5 to about 90 percent, from about 5 to about 80 percent, from about 5 to about 70 percent, from about 10 to about 99 percent, from about 10 to about 95 percent, from about 10 to about 90 percent, from about 10 to about 80 percent, from about 10 to about 70 percent, from about 25 to about 99 percent, 25 to about 95 percent, from about 25 to about 90 percent, from about 25 to about 80 percent, from about 25 to about 70 percent, from about 30 to about 99 percent, from about 30 to about 95 percent, from about 30 to about 90 percent, from about 30 to about 80 percent, from about 30 to about 70 percent, from about 40 to about 99 percent, from about 40 to about 95 percent, from about 40 to about 90 percent, from about 40 to about 80 percent, from about 40 to about 70 percent, from about 50 to about 99 percent, from about 50 to about 95 percent, from about 50 to about 90 percent, from about 50 to about 80 percent, or even from about 50 to about 70 percent.

In some embodiments, the ratio of the weight of the resin of the microporous protection layer to total weight of particulate (sum of the electrically conductive particulate and non-electrically conductive particulate) is from about 1/99 to about 10/1, from about 1/20 to about 10/1, from about 1/10 to about 10/1, from about 1/5 to about 10/1, from about 1/4 to about 10/1, from about 1/3 to about 10/1, from about 1/2 to about 10/1, from about 1/99 to about 9/1, from about 1/20 to about 9/1, from about 1/10 to about 9/1, from about 1/5 to about 9/1, from about 1/4 to about 9/1, from about 1/3 to about 9/1, from about 1/2 to about 9/1, from about 1/99 to about 8/1, from about 1/20 to about 8/1, from about 1/10 to about 8/1, from about 1/5 to about 8/1, from about 1/4 to about 8/1, from about 1/3 to about 8/1, from about 1/2 to about 8/1, from about 1/99 to about 7/1, from about 1/20 to about 7/1, from about 1/10 to about 7/1, from about 1/5 to about 7/1, from about 1/4 to about 7/1, from about 1/3 to about 7/1, from about 1/2 to about 7/1, from about 1/99 to about 6/1, from about 1/20 to about 6/1, from about 1/10 to about 6/1, from about 1/5 to about 6/1, from about 1/4 to about 6/1, from about 1/3 to about 6/1, or even from about 1/2 to about 6/1.

Microporous protection layers, electrode assemblies and methods of making them are disclosed in U.S. Provisional Patent Application Ser. No. 62/137,504, entitled “Membrane Assemblies, Electrode Assemblies, Membrane-Electrode Assemblies and Electrochemical Cells and Liquid Flow Batteries Therefrom”, which has previously been incorporated herein by reference in its entirety. Electrode assemblies may be fabricated, for example, by laminating a major surface of a previously formed porous electrode to a previously formed surface of a microporous protection layer, heat and or pressure may be used to facilitate the laminating process) or by coating at least one major surface of a porous electrode with a microporous protection layer coating, then curing and/or drying the coating to form a microporous protection layer and, subsequently, an electrode assembly.

The porous electrodes, membrane-electrode assemblies and electrode assemblies of the present disclosure may provide improved cell short resistance and cell resistance. Cell short resistance is a measure of the resistance an electrochemical cell has to shorting, for example, due to puncture of the membrane by conductive fibers of the electrode. In some embodiments, a test cell, which includes at least one of an electrode or membrane-electrode assembly of the present disclosure may have a cell short resistance of greater than 1000 ohm-cm², greater than 5000 ohm-cm² or even greater than 10000 ohm-cm². In some embodiments the cell short resistance may be less than about 10000000 ohm-cm². Cell resistance is a measure of the electrical resistance of an electrochemical cell through the membrane assembly, i.e. laterally across the cell, shown in FIG. 3. In some embodiments, a test cell, which includes at least one of an electrode and a membrane-electrode assembly of the present disclosure may have a cell resistance of between about, 0.01 and about 10 ohm-cm², 0.01 and about 5 ohm-cm², between about 0.01 and about 1 ohm-cm², between about 0.04 and about 0.5 ohm-cm² or even between about 0.07 and about 0.1 ohm-cm².

In some embodiments of the present disclosure, the liquid flow battery may be a redox flow battery, for example, a vanadium redox flow battery (VRFB), wherein a V³⁺/V²⁺ sulfate solution serves as the negative electrolyte (“anolyte”) and a V⁵⁺/V⁴⁺ sulfate solution serves as the positive electrolyte (“catholyte”). It is to be understood, however, that other redox chemistries are contemplated and within the scope of the present disclosure, including, but not limited to, V²⁺/V³⁺ vs. Br⁻/ClBr₂, Br₂/Br⁻ vs. S/S²⁻, Br⁻/Br₂ vs. Zn²⁺/Zn, Ce⁴⁺/Ce³⁺ vs. V²⁺/V³⁺, Fe³⁺/Fe²⁺ vs. Br₂/Br, Mn²⁺/Mn³⁺ vs. Br₂/Br, Fe³⁺/Fe²⁺ vs. Ti²⁺/Ti⁴⁺ and Cr³⁺/Cr²⁺, acidic/basic chemistries. Other chemistries useful in liquid flow batteries include coordination chemistries, for example, those disclosed in U.S. Pat. Appl. Nos. 2014/028260, 2014/0099569, and 2014/0193687 and organic complexes, for example, U.S. Pat. Publ. No. 2014/370403 and international application published under the patent cooperation treaty Int. Publ. No. WO 2014/052682, all of which are incorporated herein by reference in their entirety.

Methods of making membrane-electrode assemblies include laminating the exposed surface of a membrane, e.g. and ion exchange membrane, to a first major surface of a porous electrode according to any one of the porous electrode embodiments of the present disclosure. This may be conducted by hand or under heat and/or pressure using conventional lamination equipment. Additionally, the membrane-electrode assembly may be formed during the fabrication of an electrochemical cell or battery. The components of the cell may be layered on top of one another in the desired order, for example, a first porous electrode, membrane, i.e. an ion exchange membrane, and a second porous electrode. The components are then assembled between, for example, the end plates of a single cell or bipolar plates of a stack having multiple cells, along with any other required gasket/sealing material. The plates, with membrane assembly there between, are then coupled together, usually by a mechanical means, e.g. bolts, clamps or the like, the plates providing a means for holding the membrane assembly together and in position within the cell.

In another embodiment, the present disclosure provides an electrochemical cell including at least one porous electrode according to any one of the porous electrodes of the present disclosure. In yet another embodiment, the present disclosure provides an electrochemical cell including a membrane-electrode assembly according to any one of the membrane-electrode assemblies of the present disclosure. In another embodiment, the present disclosure provides an electrochemical cell including at least one electrode assembly according to any one of the electrode assemblies of the present disclosure. FIG. 3 shows a schematic cross-sectional side view of electrochemical cell 200, which includes membrane-electrode assembly 100 or 102, end plates 50 and 50′ having fluid inlet ports, 51a and 51a′, respectively, and fluid outlet ports, 51b and 51b′, respectively, flow channels 55 and 55′, respectively and first surface 50a and 52a respectively. Electrochemical cell 200 also includes current collectors 60 and 62. Membrane-electrode assembly 100 or 102 are as described in FIGS. 1A and 1C, respectively (without optional release liners 30 and 32). Electrochemical cell 200 includes porous electrodes 40 and 42, and ion exchange membrane 20, all as previously described. End plates 50 and 50′ are in electrical communication with porous electrodes 40 and 42, respectively, through surfaces 50a and 52a, respectively. Porous electrode 40 may be replaced with an electrode assembly according to any one of the electrode assemblies of the present disclosure, e.g. electrode assembly 140, producing an electrochemical cell which includes an electrode assembly of the present disclosure. Second porous electrode 42 may be any one of the porous electrodes of the present disclosure or may be replace with an electrode assembly according to any one of the electrode assemblies of the present disclosure, e.g. electrode assembly 140. If an electrode assembly is used, the microporous protection layer of the electrode assembly is adjacent, proximate or in contact with the ion exchange membrane 20. Support plates, not shown, may be placed adjacent to the exterior surfaces of current collectors 60 and 62. The support plates are electrically isolated from the current collector and provide mechanical strength and support to facilitate compression of the cell assembly. End plates 50 and 50′ include fluid inlet and outlet ports and flow channels that allow anolyte and catholyte solutions to be circulated through the electrochemical cell. Assuming the anolyte is flowing through plate 50 and the catholyte is flowing through plate 50′, the flow channels 55 allow the anolyte to contact and flow into porous electrode 40, facilitating the oxidation-reduction reactions of the cell. Similarly, for the catholyte, the flow channels 55′ allow the catholyte to contact and flow into porous electrode 42, facilitating the oxidation-reduction reactions of the cell. The current collectors may be electrically connected to an external circuit.

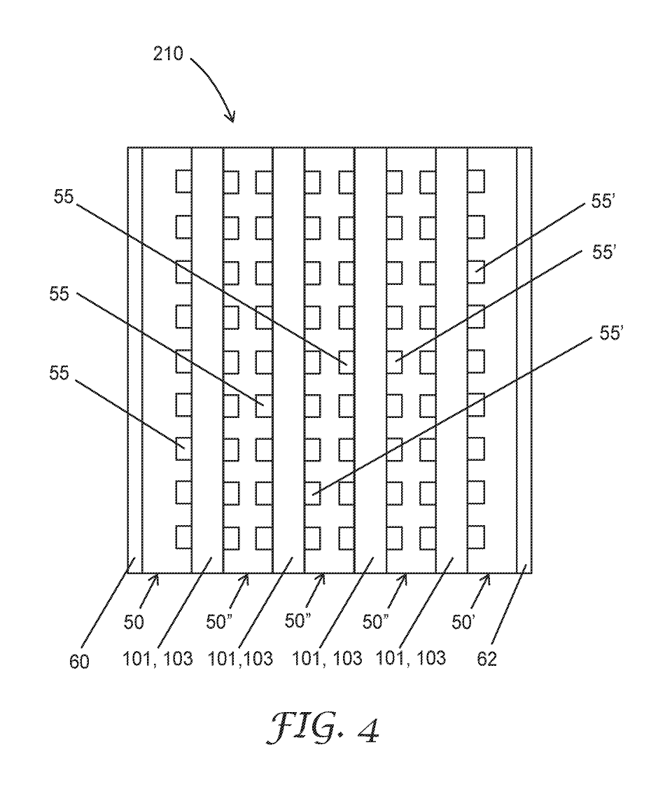

The electrochemical cells of the present disclosure may include multiple electrode-membrane assemblies fabricated from at least one of the porous electrode embodiments of the present disclosure. The membrane-electrode assemblies may include a microporous protection layer, thus a membrane electrode assembly that includes a microporous protection layer will inherently have an electrode assembly, which includes a porous electrode and microporous protection layer. In one embodiment of the present disclosure, an electrochemical cell is provided including at least two membrane-electrode assemblies, according to any one of the membrane-electrode assemblies described herein. FIG. 4 shows a schematic cross-sectional side view of electrochemical cell stack 210 including membrane-electrode assemblies 101 or 103 (as previously described), for example, separated by bipolar plates 50″ and end plates 50 and 50′ having flow channels 55 and 55′. Bipolar plates 50″ allow anolyte to flow through one set of channels, 55 and catholyte to flow through a seconds set of channels, 55′, for example. Cell stack 210 includes multiple electrochemical cells, each cell represented by a membrane-electrode assembly and the corresponding adjacent bipolar plates and/or end plates. Support plates, not shown, may be placed adjacent to the exterior surfaces of current collectors 60 and 62. The support plates are electrically isolated from the current collector and provide mechanical strength and support to facilitate compression of the cell assembly. The anolyte and catholyte inlet and outlet ports and corresponding fluid distribution system are not shown. These features may be provided as known in the art.

The porous electrodes of the present disclosure may be used to fabricate a liquid flow battery, e.g. a redox flow battery. In some embodiments, the present disclosure provides a liquid flow battery that include at least one porous electrode according to any one of the porous electrode embodiments of the present disclosure. The number of porous electrode of the liquid flow battery, which may correlate to the number of cells in a stack, is not particularly limited. In some embodiments, the liquid flow battery includes at least 1, at least 2, at least 5, at least 10 or even at least 20 porous electrodes. In some embodiments the number of porous electrodes of the liquid flow battery ranges from 1 to about 500, 2 to about 500, from 5 to about 500, from 10 to about 500 or even from 20 to about 500. In another embodiment, the present disclosure provides a liquid flow battery including at least one membrane-electrode assembly according to any one of the membrane-electrode assembly embodiments of the present disclosure. The number of membrane-electrode assemblies of the liquid flow battery, which may correlate to the number of cells in a stack, is not particularly limited. In some embodiments, the liquid flow battery includes at least 1, at least 2, at least 5, at least 10 or even at least 20 membrane-electrode assemblies. In some embodiments the number of membrane-electrode assemblies of the liquid flow battery ranges from 1 to about 500, 2 to about 500, from 5 to about 500, from 10 to about 200 or even from 20 to about 500. In yet another embodiment, the present disclosure provides a liquid flow battery including at least one electrode assembly according to any one of the electrode assembly embodiments of the present disclosure. The number of electrode assemblies of the liquid flow battery, which may correlate to the number of cells in a stack, is not particularly limited. In some embodiments, the liquid flow battery includes at least 1, at least 2, at least 5, at least 10 or even at least 20 electrode assemblies. In some embodiments the number of assemblies of the liquid flow battery ranges from 1 to about 500, 2 to about 500, from 5 to about 500, from 10 to about 500 or even from 20 to about 500.

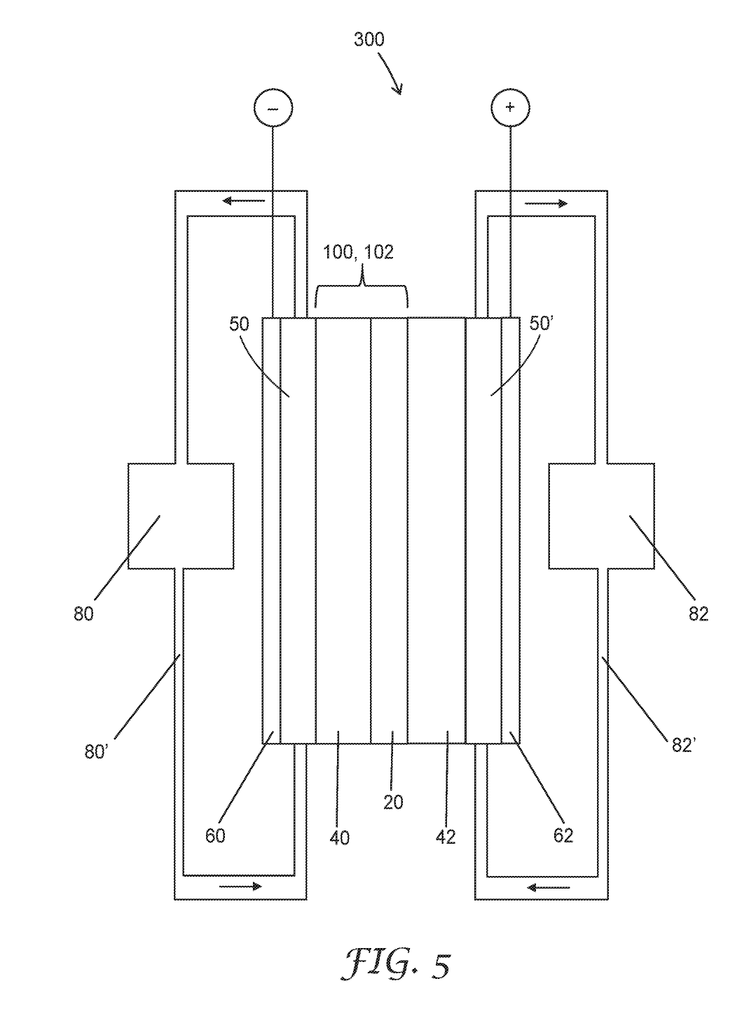

FIG. 5 shows a schematic view of an exemplary single cell, liquid flow battery including membrane-electrode assembly 100 or 102 which includes ion exchange membrane 20 and porous electrodes 40 and 42, and end plates 50 and 50′, current collectors 60 and 62, anolyte reservoir 80 and anolyte fluid distribution 80′, and catholyte reservoir 82 and catholyte fluid distribution system 82′. Pumps for the fluid distribution system are not shown. First porous electrode 40 may be replaced with an electrode assembly according to any one of the electrode assemblies of the present disclosure, e.g. electrode assembly 140. Second electrode 42 may be any one of the porous electrodes of the present disclosure or may be replace with an electrode assembly according to any one of the electrode assemblies of the present disclosure, e.g. electrode assembly 140, producing liquid flow battery which includes an electrode assembly of the present disclosure. If an electrode assembly is used, the microporous protection layer of the electrode assembly is adjacent, proximate or in contact with the ion exchange membrane 20. Current collectors 60 and 62 may be connected to an external circuit which includes an electrical load (not shown). Although a single cell liquid flow battery is shown, it is known in the art that liquid flow batteries may contain multiple electrochemical cells, i.e. a cell stack. Further multiple cell stacks may be used to form a liquid flow battery, e. g. multiple cell stacks connected in series. The porous electrodes, the ion exchange membranes, and their corresponding membrane-electrode assemblies of the present disclosure may be used to fabricate liquid flow batteries having multiple cells, for example, multiple cell stack of FIG. 4. Flow fields may be present, but this is not a requirement.

Select embodiments of the present disclosure include, but are not limited to, the following:

In a first embodiment, the present disclosure provides a porous electrode for a liquid flow battery comprising:

a porous electrode material comprising:
a non-electrically conductive, polymer particulate; and
an electrically conductive carbon particulate; wherein the electrically conductive carbon particulate is at least one of carbon nanotubes and branched carbon nanotubes, the electrically conductive carbon particulate is adhered directly to the surface of the non-electrically conductive, polymer particulate and wherein at least a portion of the non-electrically conductive polymer particulate surface is fused to form a unitary, porous electrode material.

In a second embodiment, the present disclosure provides a porous electrode for a liquid flow battery according to the first embodiment, wherein the polymer particulate is at least one of polymer particles, polymer flakes, polymer fibers and polymer dendrites.

In a third embodiment, the present disclosure provides a porous electrode for a liquid flow battery according to the first or second embodiments, wherein at least a portion of the non-electrically conductive polymer particulate has a core-shell structure, wherein the core-shell structure includes an inner core comprising a first polymer and an outer shell comprising a second polymer.

In a fourth embodiment, the present disclosure provides a porous electrode for a liquid flow battery according to the third embodiment, wherein the second polymer has a softening temperature that is lower than softening temperature of the first polymer.

In a fifth embodiment, the present disclosure provides a porous electrode for a liquid flow battery according any one of the first through fourth embodiments, wherein the amount of electrically conductive carbon particulate in the porous electrode material is from about 60 to about 99 percent, on a weight basis.

In a sixth embodiment, the present disclosure provides a porous electrode for a liquid flow battery according to any one the first through fifth embodiments, wherein the electrically conductive carbon particulate is carbon nanotubes and branched carbon nanotubes.

In a seventh embodiment, the present disclosure provides a porous electrode for a liquid flow battery according to the sixth embodiment, wherein the weight fraction of branched carbon nanotubes relative to the total weight of carbon nanotubes and branched carbon nanotubes is from about 0.1 to about 1.

In an eighth embodiment, the present disclosure provides a porous electrode for a liquid flow battery according to any one the first through seventh embodiments, wherein the diameter of the carbon nanotubes and the diameter of the main carbon nanotube of the branched carbon nanotubes is from about 0.3 nanometers to about 100 nanometers.

In a ninth embodiment, the present disclosure provides a porous electrode for a liquid flow battery according to any one of the first through eighth embodiments, wherein the electrically conductive carbon particulate has enhanced electrochemical activity, produced by at least one of chemical treatment, thermal treatment and plasma treatment.

In a tenth embodiment, the present disclosure provides a porous electrode for a liquid flow battery according to the first through ninth embodiments, wherein the electrically conducive particulate further comprises graphite particulate and wherein the weight fraction of graphite particulate to the total weight of electrically conductive carbon particulate is from about 0.05 to about 1.

In an eleventh embodiment, the present disclosure provides a membrane-electrode assembly for a liquid flow battery comprising:

an ion exchange membrane having a first surface and an opposed second surface; and a first porous electrode, according to any one of the first through tenth embodiments, having a first major surface and a second major surface, wherein the first major surface of the first porous electrode is adjacent the first surface of the ion exchange membrane.

In a twelfth embodiment, the present disclosure provides a membrane-electrode assembly according to the eleventh embodiment, wherein the polymer particulate is at least one of polymer particles, polymer flakes, polymer fibers and polymer dendrites.

In a thirteenth embodiment, the present disclosure provides a porous electrode for a liquid flow battery according to the eleventh or twelfth embodiments, wherein at least a portion of the non-electrically conductive polymer particulate has a core-shell structure, wherein the core-shell structure includes an inner core comprising a first polymer and an outer shell comprising a second polymer.

In a fourteenth embodiment, the present disclosure provides a membrane-electrode assembly according to the thirteenth embodiment, wherein the second polymer has a softening temperature that is lower than softening temperature of the first polymer.

In a fifteenth embodiment, the present disclosure provides a membrane-electrode assembly according to any one of the eleventh through fourteenth embodiments, wherein the amount of electrically conductive carbon particulate in the porous electrode material is from about 60 to about 99 percent, on a weight basis.

In a sixteenth embodiment, the present disclosure provides a membrane-electrode assembly according to any one of the eleventh through fifteenth embodiments, wherein the electrically conductive carbon particulate is carbon nanotubes and branched carbon nanotubes.

In a seventeenth embodiment, the present disclosure provides a membrane-electrode assembly according to the sixteenth embodiment, wherein the weight fraction of branched carbon nanotubes relative to the total weight of carbon nanotubes and branched carbon nanotubes is from about 0.1 to about 1.

In an eighteenth embodiment, the present disclosure provides a membrane-electrode assembly for a liquid flow battery according to any one of the eleventh through seventeenth embodiments, wherein the diameter of the carbon nanotubes and the diameter of the main carbon nanotube of the branched carbon nanotubes is from about 0.3 nanometers to about 100 nanometers.

In an nineteenth embodiment, the present disclosure provides a membrane-electrode assembly for a liquid flow battery according to any one of the eleventh through eighteenth embodiments, wherein the electrically conductive carbon particulate has enhanced electrochemical activity, produced by at least one of chemical treatment, thermal treatment and plasma treatment.

In a twentieth embodiment, the present disclosure provides a membrane-electrode assembly for a liquid flow battery according to any one of the eleventh through nineteenth embodiments, wherein the electrically conducive particulate further comprises graphite particulate and wherein the weight fraction of graphite particulate to the total weight of electrically conductive particulate is from about 0.05 to about 1.

In a twenty-first embodiment, the present disclosure provides a membrane-electrode assembly for a liquid flow battery according to any one of the eleventh through twentieth embodiments further comprising a second porous electrode, according to any one of the first through tenth embodiments, having a first major surface and a second major surface, wherein the first major surface of the second porous electrode is adjacent the second surface of the ion exchange membrane.

In a twenty-second embodiment, the present disclosure provides a membrane-electrode assembly for a liquid flow battery according to any one of the eleventh through twenty-first embodiments further comprising a first microporous protection layer disposed between the ion exchange membrane and the first porous electrode, wherein the first microporous protection layer comprises a polymer resin and an electrically conductive carbon particulate and, optionally, a non-electrically conductive particulate.

In a twenty-third embodiment, the present disclosure provides a membrane-electrode assembly for a liquid flow battery according to the twenty-first embodiment further comprising a first microporous protection layer disposed between the ion exchange membrane and the first porous electrode and a second microporous protection layer disposed between the ion exchange membrane and the second porous electrode, wherein the first and second microporous protection layers each comprise a polymer resin and an electrically conductive carbon particulate and, optionally, a non-electrically conductive particulate. In a twenty-fourth embodiment, the present disclosure provides an electrode assembly for a liquid flow battery comprising:

a first porous electrode according to any one of the first through tenth embodiments, having a first major surface and a second major surface; and

a first microporous protection layer having a first surface and an opposed second surface; wherein the first major surface of the porous electrode is proximate the second surface of the first microporous protection layer and wherein the first microporous protection layer comprises a polymer resin and an electrically conductive carbon particulate and, optionally, a non-electrically conductive particulate.

In a twenty-fifth embodiment, the present disclosure provides an electrode assembly for a liquid flow battery according to the twenty-fourth embodiment, wherein the polymer particulate of the first porous electrode is at least one of polymer particles, polymer flakes, polymer fibers and polymer dendrites.

In a twenty-sixth embodiment, the present disclosure provides an electrode assembly for a liquid flow battery according to the twenty-fourth or twenty-fifth embodiments, wherein at least a portion of the non-electrically conductive polymer particulate of the first porous electrode has a core-shell structure, wherein the core-shell structure includes an inner core comprising a first polymer and an outer shell comprising a second polymer.

In a twenty-seventh embodiment, the present disclosure provides an electrode assembly for a liquid flow battery according to the twenty-sixth embodiment, wherein the second polymer has a softening temperature that is lower than softening temperature of the first polymer.

In a twenty-eighth embodiment, the present disclosure provides an electrode assembly for a liquid flow battery according to any one of the twenty-fourth through twenty-seventh embodiments, wherein the amount of electrically conductive carbon particulate in the porous electrode material is from about 60 to about 99 percent, on a weight basis.

In a twenty-ninth embodiment, the present disclosure provides an electrode assembly for a liquid flow battery according to any one of the twenty-fourth through twenty-eighth embodiments, wherein the electrically conductive carbon particulate of the first porous electrode is carbon nanotubes and branched carbon nanotubes.

In a thirtieth embodiment, the present disclosure provides an electrode assembly for a liquid flow battery according to the twenty-ninth embodiment, wherein the weight fraction of branched carbon nanotubes relative to the total weight of carbon nanotubes and branched carbon nanotubes is from about 0.1 to about 1.

In a thirty-first embodiment, the present disclosure provides an electrode assembly for a liquid flow battery according to any one of the twenty-fourth through thirtieth embodiments, wherein the diameter of the carbon nanotubes and the diameter of the main carbon nanotube of the branched carbon nanotubes is from about 0.3 nanometers to about 100 nanometers.

In a thirty-second embodiment, the present disclosure provides an electrode assembly for a liquid flow battery according to any one of the twenty-fourth through thirty-first embodiments, wherein the electrically conductive carbon particulate has enhanced electrochemical activity, produced by at least one of chemical treatment, thermal treatment and plasma treatment

In a thirty-third embodiment, the present disclosure provides an electrode assembly for a liquid flow battery according to any one of the twenty-fourth through thirty-second embodiments, wherein the electrically conducive particulate further comprises graphite particulate and wherein the weight fraction of graphite particulate to the total weight of electrically conductive particulate is from about 0.05 to about 1.

In a thirty-fourth embodiment, the present disclosure provides an electrochemical cell for a liquid flow battery comprising: a porous electrode according to anyone of the first through tenth embodiments.

In a thirty-fifth embodiment, the present disclosure provides an electrochemical cell for a liquid flow battery comprising: a membrane-electrode assembly according to anyone of the eleventh through twenty-third embodiments.

In a thirty-sixth embodiment, the present disclosure provides an electrochemical cell for a liquid flow battery comprising: an electrode assembly according to any one of the twenty-fourth through thirty-third embodiments.

In a thirty-seventh embodiment, the present disclosure provides a liquid flow battery comprising: at least one porous electrode according to anyone of the first through tenth embodiments.

In a thirty-eighth embodiment, the present disclosure provides a liquid flow battery comprising: at least one membrane-electrode assembly according to any one of the eleventh through twenty-third embodiments.

In a thirty-ninth embodiment, the present disclosure provides a liquid flow battery comprising: at least one electrode assembly according to the twenty-fourth through thirty-third embodiments.

### EXAMPLES

Electrode-separator assemblies with carbon nanotubes were prepared using coating and laminating methods. The resultant electrode assembly's provide improved cell resistance as shown in the following examples.

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company, St. Louis, Mo. unless otherwise noted. All water used was DI water.

### Material List

Materials

| Abbreviation | |
|---|---|
| or Trade Name | Description |
| GF250 | Pitch based carbon fiber with electrical resistivity |
| | of 1.5 × 10⁻⁶ Ωm, available under the trade |
| | designation “GRANOC XN-100-25M” from |
| | Nippon Graphite Fiber Corporation, Tokyo, Japan. |
| BCNT | Polyethylene glycol encapsulated branched carbon |
| | nanotube pellets, available under the trade |
| | designation “CNS PEG Encapsulated Flake” from |
| | Applied Nanostructured Solutions, LLC, |
| | Baltimore, MD, USA. |
| LITX 200 | Hydrophilic conductive carbon additives with |
| | good dispersibility for both solvent- and water- |
| | based electrode slurry processing, available under |
| | the trade designation “LITX 200” from Cabot |
| | Corporation, Boston, Massachusetts. |
| PTFE | 1.25″ long, TEFLON ® brand PTFE staple fibers |
| | suitable for high temperature or chemically |
| | volatile applications, available under the trade |
| | designation “TEFLON ® PTFE Staples” from |
| | Toray Fluorofibers (America) Inc., Decatur, AL, |
| | USA. |
| TREVIRA | Core-sheath |
| 255 | polyethyleneteraphthalate/polyethylene |
| | bicomponent staple fiber for airlaid application, |
| | with a sheath melt point of 127° C., available under |
| | the trade designation “TREVIRA 255” from |
| | Trevira The Fibre Company, Bobingen, Germany |
| POLYCUP | Water-soluble, polyamine-polyamide polymer |
| 1884 | resin, available under the trade designation |
| | “POLYCUP1884 Polymeric Resin” from Solenis |
| | LLC, Wilmington, DE, USA |
| A200 | Hydrophilic fumed silica with a specific surface |
| | area of 200 m2/g, available under the trade |
| | designation “AEROSIL 200” from Evonik |
| | Industries, Essen, Germany. |
| ANS | Cross-linked multiwall carbon nanotube-based |
| | networks post coated with polyethylene glycol, |
| | available under the trade designation“ POST0118” |
| | from Applied NanoStructured Solutions LLC, |
| | Baltimore, MD. |
| PCT00056 | Multiwall carbon nanotube-based |
| | carbon nanostructures added to the glass fiber |
| | surface, available under the trade designation |
| | “PCT00056” from Applied NanoStructured |
| | Solutions LLC, Baltimore, MD. |

Formulation Mixing Procedure

The electrodes formulations were mixed with following method. The formulation solid weight percent are described in Table 1. All Examples were made for a total of 2 grams of solids. The exception being Example 3, where Example 3 was 5.0 grams of total solids. If one of the materials was not used that step was skipped and the procedure was continued.
1. 60 grams of solvent A was weighed out into a 250 ml glass jar which included a Teflon magnetic stir bar. The jar was placed on a magnetic stir plate and turned on to a medium setting.
2. 6 grams of solvent B was added to the jar.
3. The ANS pellets were crushed, by hand, to create a powder. The powder was then slowly added to the solvent mixture jar.
4. The conductive fibers were then added to the mixture.
5. The binder fibers were added.
6. The binder resin was added.
7. The non-conductive filler was added.
8. After all materials were added, the mixture was stirred for an additional 5 minutes.

TABLE 1
Electrode Formulations.

| | | | | | | | Non | | | | |
|---|---|---|---|---|---|---|---|---|---|---|---|
| | | | | | | | Conductive | | | | Binding |
| | Solvents | | | Conductive Fibers | | | Filler | | Binding fibers | | Resin |
| | Solvent | Solvent | ANS | | | LITX | Glass | | | TREVIRA | POLYCUP |
| | A | B | ANS | GF250 | BCNT | 200 | Fiber | A200 | PTFE | 255 | 1884 |
| Example | Water | Acetone | 40% | 50% | 0% | 0% | 0% | 0% | 5% | 0% | 5% |
| 1 | | | | | | | | | | | |
| Example | Water | Acetone | 27% | 27% | 0% | 0% | 0% | 0% | 43% | 0% | 3% |
| 2 | | | | | | | | | | | |
| Example | Water | Acetone | 40% | 50% | 0% | 0% | 0% | 0% | 5% | 0% | 5% |
| 3 | | | | | | | | | | | |
| Example | Water | None | 40% | 50% | 0% | 0% | 0% | 0% | 0% | 10% | 0% |
| 4 | | | | | | | | | | | |
| Example | Water | None | 40% | 50% | 0% | 0% | 0% | 0% | 0% | 0% | 10% |
| 5 | | | | | | | | | | | |
| Example | Water | None | 40% | 0% | 50% | 0% | 0% | 0% | 0% | 10% | 0% |
| 6 | | | | | | | | | | | |
| Example | Water | Acetone | 40% | 40% | 0% | 0% | 0% | 10% | 10% | 0% | 0% |
| 7 | | | | | | | | | | | |
| Example | Water | Acetone | 40% | 40% | 0% | 0% | 0% | 10% | 5% | 0% | 5% |
| 8 | | | | | | | | | | | |
| Example | Water | Acetone | 40% | 50% | 0% | 0% | 5% | 0% | 0% | 0% | 5% |
| 9 | | | | | | | | | | | |
| Example | Water | Acetone | 30% | 50% | 0% | 10% | 0% | 0% | 5% | 0% | 5% |
| 10 | | | | | | | | | | | |

Felt Making Procedure

A 110 mm ceramic Buchner funnel was connected to a 500 ml side arm flask by means of a rubber adapter. Rubber tubing was connected to the side arm and connected to a vacuum pump (Available form Edwards, Glenwillow, Ohio, Model E2M 1.5) For each sample, 2 pieces of #40 ashless 110 mm filter paper, (commercially available from GE Healthcare Company, Little Chalfont, Buckinghamshire, United Kingdom) were placed on top of the perforated holes in the Buchner funnel. An acrylic tube was placed on top of the filter paper, inside the Buchner funnel, this tube prevented overflow of the material when the electrode was formed. The tube had an inside diameter of 3.9 inches (9.9 cm) and was 6 (15 cm) inches in length.

To form the electrode, the vacuum was turned on and the filter paper was wetted with DI water. Vacuum was turned off after the filter paper is completely wet. The formulation was removed from the stir plate and poured on top of the filter paper. Vacuum was turned on again and run until the water was removed from the sample, approximately 30 seconds. The vacuum was then turned off and the sample and filter papers were removed from the funnel. The outside filter paper was removed and the sample and adjacent filter were placed in an oven at 150 degrees centigrade for 30 minutes. Following drying of the sample, the sample is manually removed from the filter paper.

Effective Electrode Resistance Measurement

The samples were then cut into 7 cm×7 cm squares for conductivity testing. The samples were placed between two graphite plates that have serpentine flow channels. The flow plates of the test cell were commercially available quad serpentine flow channel with 25 cm² active area, available from Fuel Cell Technologies, Albuquerque, N. Mex. They were then pressed to the desired compressions using gaskets that set the gap to achieve the target compression levels. Using power supply TDK-Lambda ZUP 10-40, a constant 35 A current was applied across the sample, and the resistance between the two plates was measured using a KEITHLEY 197 A Autoranging microvolt DMM. The effective resistance across the samples are in Table 2 below.

TABLE 2
Effective Electrode Resistance.

| | Effective Resistance (mΩ) | | | | | | | | | |
|---|---|---|---|---|---|---|---|---|---|---|
| % | Example # | | | | | | | | | |
| Compression | 1 | 2 | 3 | 4 | 5 | 6 | 7 | 8 | 9 | 10 |
| 10 | | | | | | | | | 0.732 | |
| 20 | | | | | | | 1.061 | 0.680 | | 0.926 |
| 30 | | | | | | | | | 0.451 | |
| 40 | | | | | | | 0.608 | 0.419 | | 0.536 |
| 50 | 0.282 | 0.282 | 0.446 | 0.270 | 0.189 | 0.303 | | | | |
| 60 | 0.195 | 0.195 | 0.361 | 0.189 | 0.160 | | 0.210 | 0.244 | 0.180 | 0.182 |
| 70 | 0.168 | 0.168 | 0.229 | 0.158 | 0.126 | 0.173 | | | | |
| 80 | 0.132 | 0.132 | 0.181 | 0.126 | 0.115 | 0.145 | 0.145 | 0.168 | 0.140 | 0.134 |
| 90 | | | | | | 0.145 | | | | |
| 93 | | | 0.142 | | | | | | | |
| 97 | | | 0.140 | | | | | | | |

Current Generation Procedure and Results

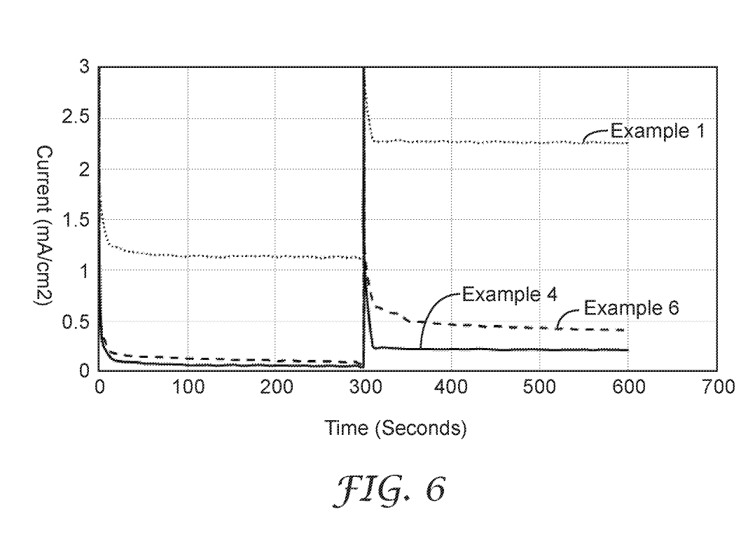

To simulate the use in a redox flow battery the following halfcell apparatus was used to generate a current. FIG. 6 shows polarization curves for Examples 1, 4 and 6 and the results of the current generation.

Hardware used: The hardware used is a modified fuel cell test fixture (commercially available from Fuel Cell Technologies, Albuquerque, N. Mex., model number SSCH) that utilizes two graphite bi-polar plates, two gold plated copper current collectors and aluminum end plates. The graphite bi-polar plates have a 5 cm2 single serpentine channel with an entry port on top and exit port on the bottom.

Assembly: The test cell is assembled by placing on one graphite plate 15.2 mils of gasket material that has a 5 cm2 area removed from the center. The felt material is placed into this cavity. Next a 50 micron, 800EW 3M membrane (800 equivalent weight proton exchange membrane prepared by following the membrane preparation procedure described in the EXAMPLE section of U.S. Pat. No. 7,348,088 and is placed over the gasket/felt assembly. Next another set of 15.2 mil gasket material with an open cavity is placed onto of the membrane and filled with a second piece of felt material. A second graphite plate is placed onto of the complete assembly to complete the test cell. The test cell is then placed between two aluminum end plates with current collectors and secured with a series of 8 bolts that are tightened to 120 in-lbs.

Mechanical operation of the cell: Connected to the entry and exit ports of the test cell is tubing that allows for delivery of the 2.8M H2SO4/1.5M VOSO4 electrolyte (both components available individually from Sigma Aldrich, St. Louis, Mo.) by a ISMATEC 931C Peristaltic pump at a flow rate of 12 ml/min. The connection of the tubing is such that the fluid is fed from an electrolyte storage vessel into the top of side one, through the test cell and exits the bottom port of side one. The fluid from the bottom of side one is then fed into the bottom port of side two, passes through the test cell, and exits the top port of side two and finally back into the electrolyte storage vessel. This describes the system as using a single electrolyte operating in a counter-flow mode. Where on one side the V+4 molecule is oxidized to V+5 and on the other side it is subsequently reduced.

Electrochemical operation of the cell: The cell as described is next connected to a Biologic MPG-205 (available from Bio-Logic Science Instruments, Claix, France) potentio/galvanostat with one current collector serving as the anode and the other current collector serving as the cathode. To perform a test the following steps are followed:
1) Insure that electrolyte is flowing through the cell.
2) Apply +100 mV vs. initial open circuit to the cell and monitor the resulting current for 5 minutes
3) Apply +200 mV vs. initial open circuit to the cell and monitor the resulting current for 5 minutes.

What is claimed:

1) A porous electrode for a liquid flow battery comprising:
a porous electrode material comprising:
a non-electrically conductive, polymer particulate; and
an electrically conductive carbon particulate; wherein the electrically conductive carbon particulate is at least one of carbon nanotubes and branched carbon nanotubes, the electrically conductive carbon particulate is adhered directly to the surface of the non-electrically conductive, polymer particulate and wherein at least a portion of the non-electrically conductive polymer particulate surface is fused to form a unitary, porous electrode material.

2) The porous electrode for a liquid flow battery of claim 1, wherein the polymer particulate is at least one of polymer particles, polymer flakes, polymer fibers and polymer dendrites.

3) The porous electrode for a liquid flow battery of claim 1, wherein at least a portion of the non-electrically conductive polymer particulate has a core-shell structure, wherein the core-shell structure includes an inner core comprising a first polymer and an outer shell comprising a second polymer-, and wherein the second polymer has a softening temperature that is lower than a softening temperature of the first polymer.

4) (canceled)

5) The porous electrode for a liquid flow battery of claim 1, wherein the amount of electrically conductive carbon particulate in the porous electrode material is from about 60 to about 99 percent, on a weight basis.

6) The porous electrode for a liquid flow battery of claim 1, wherein the electrically conductive carbon particulate is carbon nanotubes and branched carbon nanotubes.

7) (canceled)

8) (canceled)

9) The porous electrode for a liquid flow battery of claim 1, wherein the electrically conductive carbon particulate has enhanced electrochemical activity, produced by at least one of chemical treatment, thermal treatment and plasma treatment.

10) The porous electrode for a liquid flow battery of claim 1, wherein the electrically conducive particulate further comprises graphite particulate and wherein the weight fraction of graphite particulate to the total weight of electrically conductive carbon particulate is from about 0.05 to about 1.

11) A membrane-electrode assembly for a liquid flow battery comprising:
an ion exchange membrane having a first surface and an opposed second surface; and
a first porous electrode according to claim 1, having a first major surface and a second major surface, wherein the first major surface of the first porous electrode is adjacent the first surface of the ion exchange membrane.

12) The membrane-electrode assembly for a liquid flow battery of claim 11, wherein the polymer particulate is at least one of polymer particles, polymer flakes, polymer fibers and polymer dendrites.

13) The membrane-electrode assembly for a liquid flow battery of claim 11, wherein at least a portion of the non-electrically conductive polymer particulate has a core-shell structure, wherein the core-shell structure includes an inner core comprising a first polymer and an outer shell comprising a second polymer, and wherein the second polymer has a softening temperature that is lower than a softening temperature of the first polymer.

14) (canceled)

15) The membrane-electrode assembly for a liquid flow battery of claim 11, wherein the amount of electrically conductive carbon particulate in the porous electrode material is from about 60 to about 99 percent, on a weight basis.

16) The membrane-electrode assembly for a liquid flow battery of claim 11, wherein the electrically conductive carbon particulate is carbon nanotubes and branched carbon nanotubes.

17) (canceled)

18) (canceled)

19) (canceled)

20) (canceled)

21) The membrane-electrode assembly for a liquid flow battery of claim 11 further comprising a second porous electrode, according to claim 1, having a first major surface and a second major surface, wherein the first major surface of the second porous electrode is adjacent the second surface of the ion exchange membrane.

22) (canceled)

23) (canceled)

24) An electrode assembly for a liquid flow battery comprising:
a first porous electrode according to claim 1, having a first major surface and a second major surface; and
a first microporous protection layer having a first surface and an opposed second surface; wherein the first major surface of the porous electrode is proximate the second surface of the first microporous protection layer and wherein the first microporous protection layer comprises a polymer resin and an electrically conductive carbon particulate and, optionally, a non-electrically conductive particulate.

25) The electrode assembly for a liquid flow battery of claim 24, wherein the polymer particulate of the first porous electrode is at least one of polymer particles, polymer flakes, polymer fibers and polymer dendrites.

26) The electrode assembly or a liquid flow battery of claim 24, wherein at least a portion of the non-electrically conductive polymer particulate of the first porous electrode has a core-shell structure, wherein the core-shell structure includes an inner core comprising a first polymer and an outer shell comprising a second polymer-, and wherein the second polymer has a softening temperature that is lower than softening temperature of the first polymer.

27) (canceled)

28) (canceled)

29) (canceled)

30) (canceled)

31) (canceled)

32) (canceled)

33) (canceled)

34) An electrochemical cell for a liquid flow battery comprising a porous electrode according claim 1.

35) (canceled)

36) (canceled)

37) A liquid flow battery comprising at least one porous electrode according to claim 1.

38) (canceled)

39) (canceled)
